(19) United States
(12) Patent Application Publication
(10) Pub. No.: US 2018/0024976 A1
(43) Pub. Date: Jan. 25, 2018

(54) ANNOTATION PROVIDING METHOD AND DEVICE

(71) Applicant: Samsung Electronics Co., Ltd., Suwon-si, Gyeonggi-do (KR)

(72) Inventors: Ga-hyun JOO, Suwon-si (KR); Sunah KIM, Seongnam-si (KR); Jin-young LEE, Suwon-si (KR); Ji-su JUNG, Yongin-si (KR)

(21) Appl. No.: 15/541,212

(22) PCT Filed: Oct. 19, 2015
(86) PCT No.: PCT/KR2015/011049

§ 371 Date: Jun. 30, 2017

(30) Foreign Application Priority Data
Jan. 2, 2015 (KR) 10-2015-0000287

(51) Int. Cl. G06F 17/24; G06F 3/0483; G06F 17/30; G06F 3/0482

(52) U.S. Cl. CPC G06F 17/241; G06F 3/0482; G06F 3/0483; G06F 17/30268; G06F 3/04883

(57) ABSTRACT

Provided is a device including a user input unit that receives a user input for inputting a search keyword, a display unit that displays a list of annotations associated with the search keyword from among at least one annotation set to at least one content, a control unit that controls the unit input unit and the display unit, wherein the user input unit receives a user input for selecting at least one in the list of annotations, and the display unit displays content for which the selected annotation is set from among the at least one content.

### TECHNICAL FIELD

The present invention relates to a method and apparatus for providing an annotation generated by a user.

### BACKGROUND ART

With the development of multimedia technology and network technology, a device is capable of outputting various types of information. Furthermore, various methods of inputting annotations on information are being developed. For example, an annotation may be input on information in an e-book displayed on a device by using an electronic pen, and the input annotation may be stored in the e-book file.

However, since an annotation input by a user is stored in a content file, when content files are different, a user is unable to see an annotation input by himself or herself even for same content. Furthermore, in order to share an annotation input by himself or herself, a user must provide the content itself in which the annotation is stored to another user. Furthermore, in order to find an annotation input to content, it is necessary to pen the content and visually confirm all annotations.

Therefore, it is necessary to manage annotations separately from content. Furthermore, it is necessary to provide a function capable of searching for annotations.

### DESCRIPTION OF THE DRAWINGS

FIGS. 1A and 1B are diagrams showing a method by which a device provides an annotation search function, according to an embodiment of the present invention.

FIG. 2 is a flowchart of a method whereby a device provides an annotation corresponding to a user by using a cloud server, according to an embodiment of the present invention.

FIG. 3 is a diagram showing a method whereby a device stores an annotation in correspondence to a tag, according to an embodiment of the present invention.

FIGS. 4A through 4D are diagrams showing a method whereby a device generates an annotation according to a user input, according to an embodiment of the present invention.

FIGS. 5A through 5D are diagrams for describing a method whereby a device provides a user interface for inputting a tag for an annotation, according to an embodiment of the present invention.

FIGS. 6A and 6B are diagrams for describing a method whereby a device provides a user interface for setting a sharing user to share an annotation when the device stores an annotation, according to an embodiment of the present invention.

FIG. 7 is a diagram showing a database of annotations stored in a cloud server, according to an embodiment of the present invention.

FIG. 8 is a flowchart of a method whereby a device provides an annotation associated with a search keyword, according to an embodiment of the present invention.

FIG. 9 is a diagram showing a method whereby a device receives a user input for inputting a search keyword, according to an embodiment of the present invention.

FIG. 10A is a diagram showing a method whereby a device receives a user input for inputting a search keyword, when content is a moving picture, according to an embodiment of the present invention.

FIG. 10B is a diagram showing a method whereby a device receives a user input for inputting a search keyword, when content is a moving picture, according to another embodiment of the present invention.

FIG. 11 is a diagram showing a method whereby a device receives a user input for inputting a search keyword through a search window, according to an embodiment of the present invention.

FIG. 12 is a diagram showing a method whereby a device receives a user input for inputting a search keyword through a search window, according to another embodiment of the present invention.

FIG. 13 is a diagram showing a method whereby a device provides a list of annotations associated with a search keyword, according to an embodiment of the present invention.

FIG. 14 is a diagram showing a method whereby a device displays an annotation selected by a user from among annotations found based on a search keyword, according to an embodiment of the present invention.

FIG. 15 is a diagram showing a method of displaying an annotation selected by a user from among annotations found based on a search keyword, according to another embodiment of the present invention.

FIG. 16 is a flowchart of a method whereby a device provides an annotation of a user corresponding to content, as a user input for displaying the content is received, according to an embodiment of the present invention.

FIG. 17A is a diagram of a method whereby a device provides an annotation, according to an embodiment of the present invention.

FIG. 17B is a flowchart of a method whereby a device provides an annotation by using a cloud server, according to an embodiment of the present invention.

FIG. 18A is a diagram showing a method whereby a plurality of devices of a user provide annotations, according to an embodiment of the present invention.

FIG. 18B is a flowchart of a method whereby a plurality of devices of a user provide annotations, according to an embodiment of the present invention.

FIG. 19A is a diagram showing a method of sharing an annotation between users, according to an embodiment of the present invention.

FIG. 19B is a flowchart of a method of sharing annotations between users, according to an embodiment of the present invention.

FIG. 19C is a diagram showing a method of sharing annotations between users, according to another embodiment of the present invention.

FIG. 20 is a diagram showing a method whereby a device provides an annotation when the device virtually executes an application, according to an embodiment of the present invention.

FIG. 21 is a diagram showing a database of annotations stored in a cloud server according to an embodiment of the present invention.

FIG. 22 is a diagram showing a database of annotations stored in a cloud server according to another embodiment of the present invention.

FIG. 23 is a block diagram of a device, according to an embodiment of the present invention.

FIG. 24 is a block diagram of a device, according to another embodiment of the present invention.

FIG. 25 shows a block diagram of a cloud server, according to an embodiment of the present invention.

### DETAILED DESCRIPTION OF THE INVENTION

### Technical Problem

Provided are various embodiments for providing user-generated annotations.

### Best Mode

According to an aspect of the present invention, there is provided a device including a user input unit that receives a user input for inputting a search keyword, a display unit that displays a list of annotations associated with the search keyword from among at least one annotation set to at least one content, a control unit that controls the unit input unit and the display unit, wherein the user input unit receives a user input for selecting at least one in the list of annotations is received, and the display unit displays content for which the selected annotation is set from among at least one content.

Furthermore, the display unit may display information regarding first content different from the at least one content, and the user input unit may input at least one from the information in the first content as a search keyword.

Furthermore, the at least one annotation input to the at least one content may be at least one of an annotation stored in a cloud server in correspondence to the ID of the user and an annotation that is shared to the user in correspondence to the ID of the user and stored in the cloud server.

Furthermore, the device may request an annotation associated with the search keyword to the cloud server, the device may further include a communication unit for receiving a list of annotations associated with the search keyword from among at least one at least one input in correspondence to the at least one content from the cloud server, and the display unit may display the received list of annotations.

Furthermore, the list of annotations associated with the search keyword may include storage location information regarding the annotation, the control unit may obtain content in which the selected annotation is located, based on storage location information regarding the annotation, and the display unit may display information regarding location of the annotation from information in the content.

Furthermore, the display unit may display a search window, and the user input unit may input the search keywords in the search window.

Furthermore, the first content may include a plurality of objects, and the user input unit may receive a user input for setting at least one of the plurality of objects as the search keyword.

According to another aspect of the present invention, there is provided a method of providing annotation, the method including receiving a user input for inputting a search keyword, displaying a list of annotations related to the search keyword from among at least one annotations stored in correspondence to at least one content, receiving a user input for selecting one in the list of annotation, and displaying information including the selected annotation from information in the at least one content.

Furthermore, the receiving of the user input for inputting the search keyword may include displaying information in first content different from the at least one content, and receiving at least one of information in the first content as the search keyword.

Furthermore, at least one annotation input to the at least one content may be at least one of an annotation stored in a cloud server in correspondence to the ID of the user and an annotation that is shared to the user in correspondence to the ID of the user and stored in the cloud server.

Furthermore, the displaying of the list of the annotations related to the search keyword from among the at least one annotations stored in correspondence to the at least one content may include requesting an annotation associated with the search keyword to the cloud server, receiving a list of annotations associated with the search keyword from among at least one at least one input in correspondence to the at least one content from the cloud server, and displaying the received list of annotations.

Furthermore, the list of annotations associated with the search keyword may include information regarding locations at which the annotations are stored, and the displaying of the information including the selected annotation from the information in the at least one content may include obtaining content in which the selected annotation is located based on the information regarding locations at which the annotations are stored, and displaying information in which the selected annotation is located from information in the content.

Furthermore, the receiving of the user input for inputting the search keyword may include displaying a search window for searching for an annotation, and receiving a user input for inputting the search keyword in the search window.

Furthermore, the first content may include a plurality of objects, and, in the receiving of the user input for inputting the search keyword, at least one of the plurality of objects may be set as the search keyword.

### Mode of the Invention

The terms used in this specification will be briefly described, and the present invention will be described in detail below.

With respect to the terms in the various embodiments of the present disclosure, the general terms which are currently and widely used are selected in consideration of functions of structural elements in the various embodiments of the present disclosure. However, meanings of the terms may be changed according to intention, a judicial precedent, appearance of a new technology, and the like. In addition, in certain cases, a term which is not commonly used may be selected. In such a case, the meaning of the term will be described in detail at the corresponding part in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

Throughout the specification, the term “content” may refer to data that is made up of digital codes, such as characters, symbols, sounds, sounds, images, or images, and distributed. For example, content may include an electronic document, an e-book, an image, a moving picture, or a web page.

Throughout the specification, the term “annotation” may refer to information input by a user on content. For example, an annotation may include a phrase written by a user, an inserted image, or a voice input by a user on a page of an e-book displayed on a display screen. According to embodiments, an annotation may be referred to as a “personal note”.

Throughout the specification, the term “cloud server” may refer to a data storage device in which annotations are stored. The cloud server may be composed of one storage device or a plurality of storage devices.

Furthermore, the cloud server may be operated by a service provider that provides an annotation storage service to users. For example, a service provider may provide annotation storage space for users subscribed to a service. Furthermore, a cloud server may transmit an annotation of a user to a device of the user or receive an annotation of the user from a device of the user over a network.

As a user subscribes to a service provided by a service provider, the user may register his or her own account in a cloud server. The cloud server may store annotations of the user based on the account of the user registered in the cloud server. Furthermore, the cloud server may transmit stored annotations of the user to a device of the user or a device of a sharing user of the user based on the account of the user.

Furthermore, a cloud server may restrict another user from accessing annotations of a user according to the user's annotation access policy set by the user. For example, a cloud server may authorize only another user permitted by the user to access the user's annotations. Furthermore, a cloud server may authorize all users to access a user's annotations, depending on the user's configuration.

Hereinafter, embodiments of the present invention will be described in detail with reference to the accompanying drawings so that those skilled in the art can easily carry out the present invention. The present invention may, however, be embodied in many different forms and should not be construed as limited to the embodiments set forth herein. In order to clearly illustrate the present invention, parts not related to the description are omitted, and like parts are denoted by like reference numerals throughout the specification.

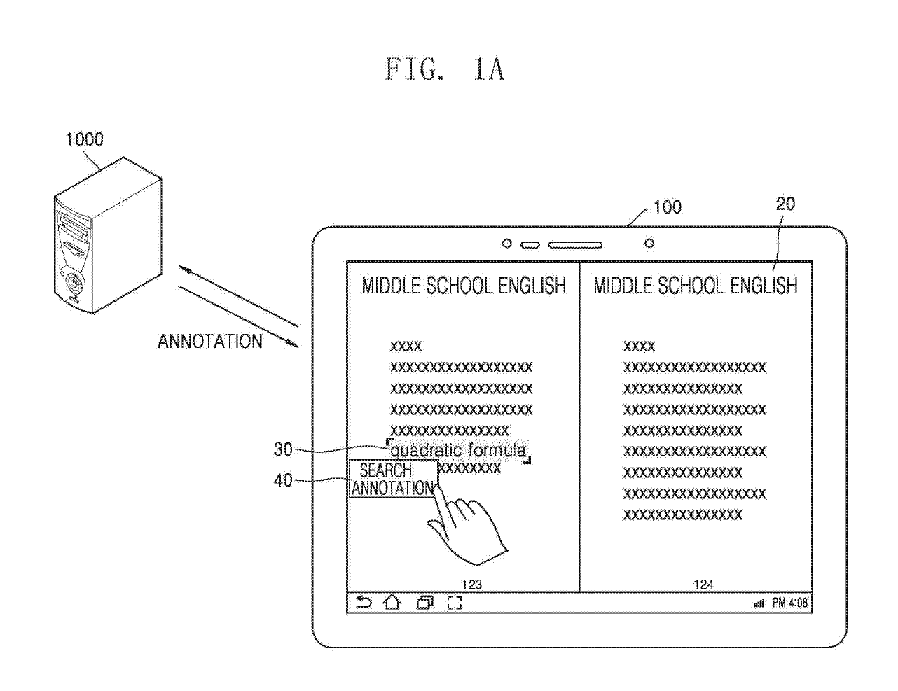

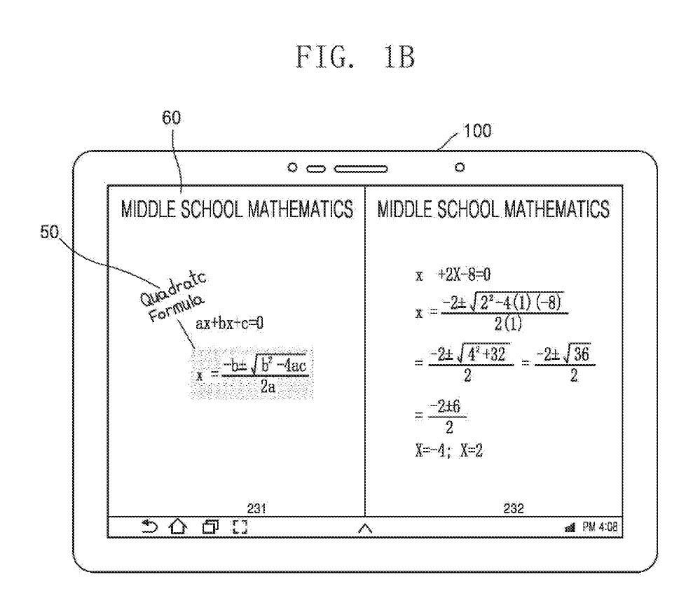

FIGS. 1A and 1B are diagrams showing a method by which a device 100 provides an annotation search function, according to an embodiment of the present invention.

Referring to FIG. 1A, the device 100 may provide an annotation search function for searching for an annotation generated by a user.

For example, the device 100 may display an e-book 20 containing “Middle School English” content. Furthermore, the device 100 may provide a user interface 40 for searching for annotations regarding a selected keyword. As a user input for selecting a vocabulary 30 indicating “quadratic formula” in the content of the “Middle School English” e-book 20 via the user interface 40, the device 100 may request an annotation associated with “quadratic formula” to a cloud server 1000.

The cloud server 1000 may determine at least one annotation associated with the search keyword “quadratic formula” received from the device 100. By determining at least one annotation associated with a search keyword, the cloud server 1000 may transmit a list of annotations associated with the search keyword to the device 100.

As the list of annotations associated with the search keyword is received from the cloud server 1000, the device 100 may display the list of annotations associated with the search keyword. For example, an annotation associated with “quadratic formula” selected as the search keyword in the “Middle School English” e-book 20 may be an annotation regarding the quadratic formula previously input by a user on the page 231 of the “Middle School Mathematics” e-book. Furthermore, an annotation associated with “quadratic formula” may be an annotation previously input by a user on the Wikipedia search page for “quadratic formula”.

Referring to FIG. 1B, as a user input that selects one in a list of annotations associated with “quadratic formula” is received, the device 100 may display information regarding the page 231 of the “Middle School Mathematics” e-book 60 and an annotation 50 associated with the quadratic formula pre-defined in the page 231 of the “ Middle School Mathematics ” e-book 60.

Therefore, by searching for annotations regarding different contents as well as same contents, a user may search for a variety of information. Furthermore, a user may search for information more conveniently by searching for an annotation previously input by himself/herself or an annotation input by another user.

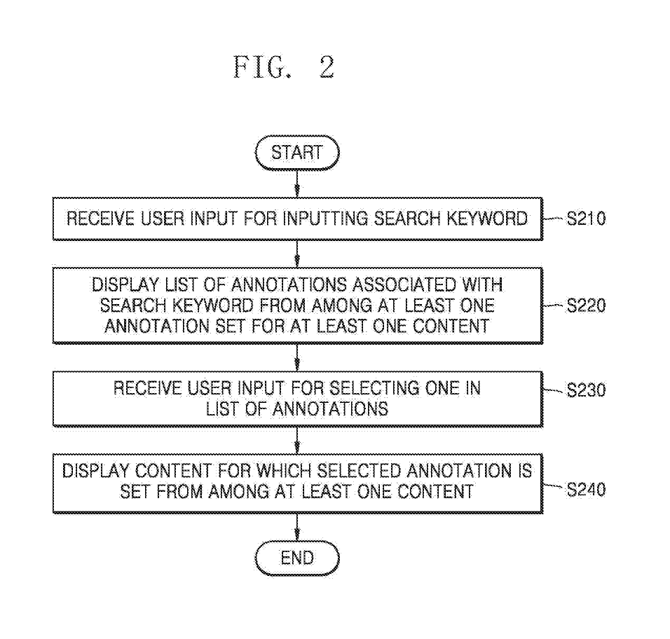

FIG. 2 is a flowchart of a method that the device 100 provides an annotation corresponding to a user by using the cloud server 1000, according to an embodiment of the present invention.

In operation S210, the device 100 may receive a user input for inputting a search keyword.

The device 100 may receive a user input that selects one of objects displayed on a display screen as a search keyword. For example, the device 100 may receive a user input that selects one of characters, images, and annotations displayed on the display screen as a search keyword.

Furthermore, the device 100 may provide a search window for inputting a search keyword.

In operation S220, the device 100 may display a list of annotations associated with the search keyword from among at least one annotation stored in correspondence to at least one content.

As a user input for inputting the search keyword is received, the device 100 may request an annotation associated with the search keyword to the cloud server 1000. An annotation search request may include the ID of a user registered in the cloud server 1000 and the search keyword.

As the annotation search request is received from the device 100, the cloud server 1000 may search for an annotation associated with the search keyword based on the search keyword. For example, the cloud server 1000 may determine at least one tag based on a search keyword and obtain an annotation stored in correspondence to the at least one determined tag.

As an annotation associated with the search keyword is obtained, the cloud server 1000 may transmit a list of annotations associated with the search keyword to the device 100.

An annotation may include a text, a image, a voice, or an image, but is not limited thereto. Furthermore, the cloud server 1000 may include identification information regarding annotation-set content, storage location information regarding the content, and information regarding location of an annotation in the content, but is not limited thereto.

When annotation-set content is a moving picture, information regarding location of the annotation in the content may be a frame number and coordinate values within the frame. Furthermore, when annotation-set content is a document, information regarding location of the annotation in the content may be a page number and coordinate values within the page. Furthermore, when annotation-set content is music, information regarding location of the annotation in the content may be a playtime.

In operation S230, the device 100 may receive a user input that selects one in the list of annotations.

When the list of annotations associated with the search keyword is received from the cloud server 1000, the device 100 may display the list of annotations. The device 100 may receive a user input that selects one in the displayed list of annotations.

In operation S240, the device 100 may display content for which the selected annotation is set from among at least one content.

As a user input for selecting one in the list of annotations is received, the device 100 may display annotation-set content and a set annotation. For example, the device 100 may obtain content based on the storage location information regarding the content. Next, based on information regarding location of an annotation in the content, the device 100 may display information in the annotation-set content and the set annotation.

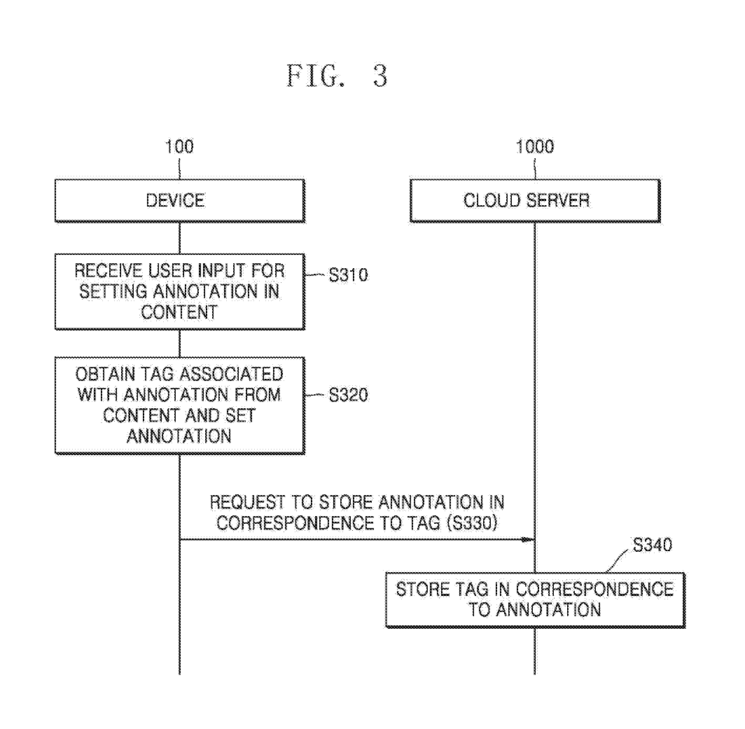

FIG. 3 is a diagram showing a method that the device 100 stores an annotation in correspondence to a tag, according to an embodiment of the present invention.

In operation S310, the device 100 may receive a user input for setting an annotation in content.

The device 100 may output information in the content. For example, the device 100 may display an e-book, a movie, an image, or a web page. Furthermore, the device 100 may output voice or music.

The device 100 may receive a user input for setting an annotation to information in content that is being output. For example, the device 100 may receive an input that writes a phrase on a displayed image. The device 100 may also receive an input to set an image on a displayed web page. The device 100 may also receive an input to record a voice for a displayed image.

Furthermore, the device 100 may receive a user input for selecting an object in content and inputting an annotation for the selected object. An object may, for example, include, but is not limited to, a particular vocabulary, image, page, or frame within the content.

In operation S320, the device 100 may obtain a tag associated with the set annotation from the content and the set annotation.

A tag associated with an annotation may be identification information regarding annotation-set content. Furthermore, when an annotation is set to a specific object in content, a tag associated with the annotation may be information regarding the object for which the annotation is set. When an object is a phrase, information regarding the object may be the phrase itself. When an object is an image, information regarding the object may be identification information regarding the image.

Furthermore, a tag associated with an annotation may be a keyword, a name, a keyword, a phrase, a footnote, and an index in content.

In operation S330, the device 100 may request a cloud server to store an annotation in correspondence to the tag.

The device 100 may store an annotation set in content as a file. For example, the device 100 may store a written phrase as an image. Furthermore, the device 100 may store a recorded voice as a voice file.

An annotation storage request may include a tag, an annotation file, identification information regarding annotation-set content, storage location information regarding the annotation-set content, information regarding location of an annotation in the content, and an ID of a user registered in a cloud server.

In operation S340, the cloud server 1000 may store an annotation corresponding to a tag.

As an annotation storage request is received from the device 100, the cloud server 1000 may store a received annotation in correspondence to the tag.

In this case, the cloud server 1000 may determine whether a user is authorized to store an annotation based on an ID of the user received from the device 100. When the user is authorized to store an annotation, the cloud server 1000 may store the received annotation in correspondence to the tag.

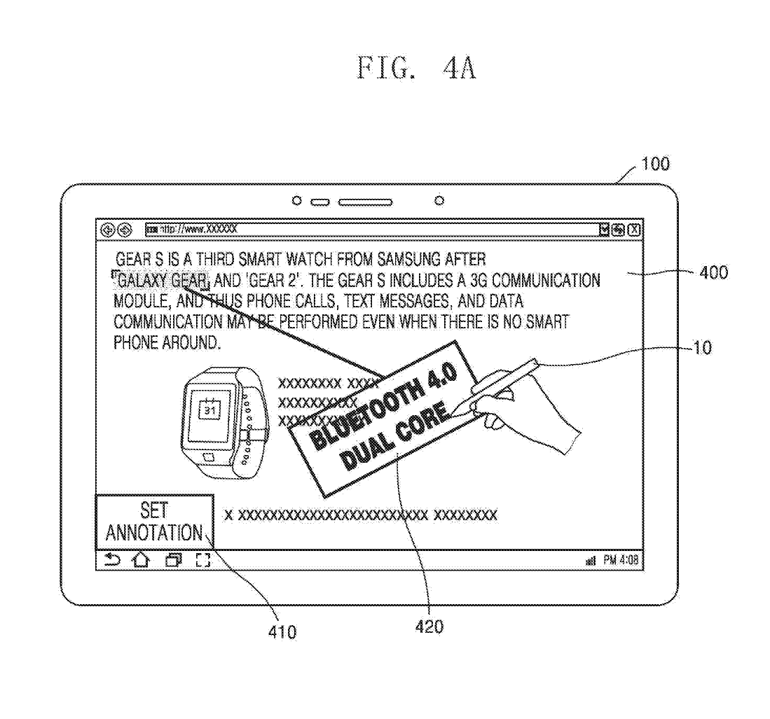

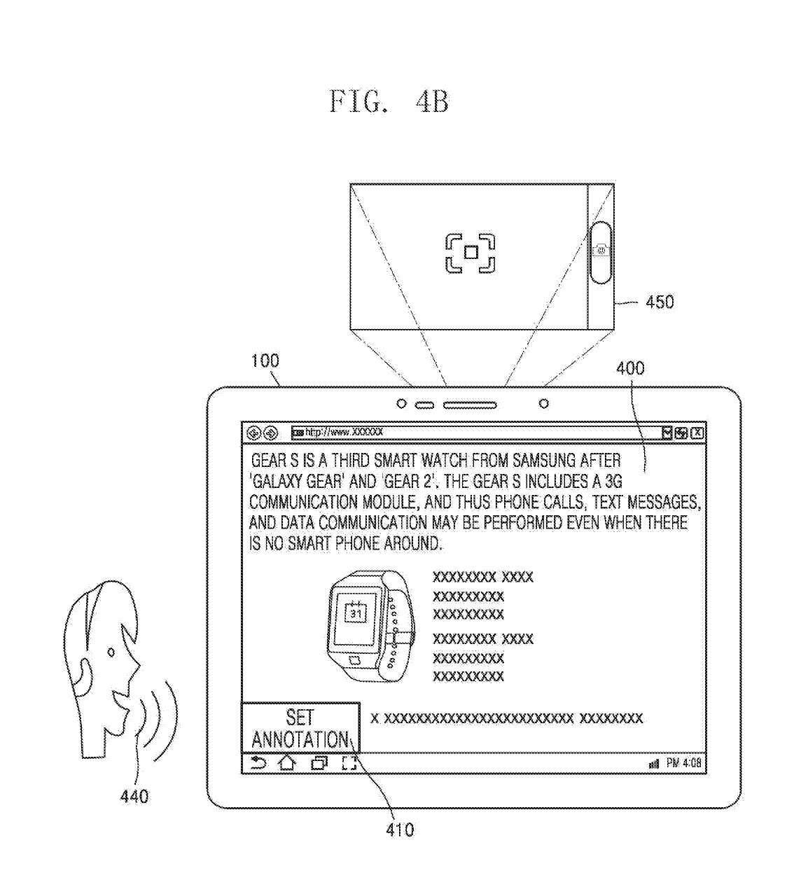

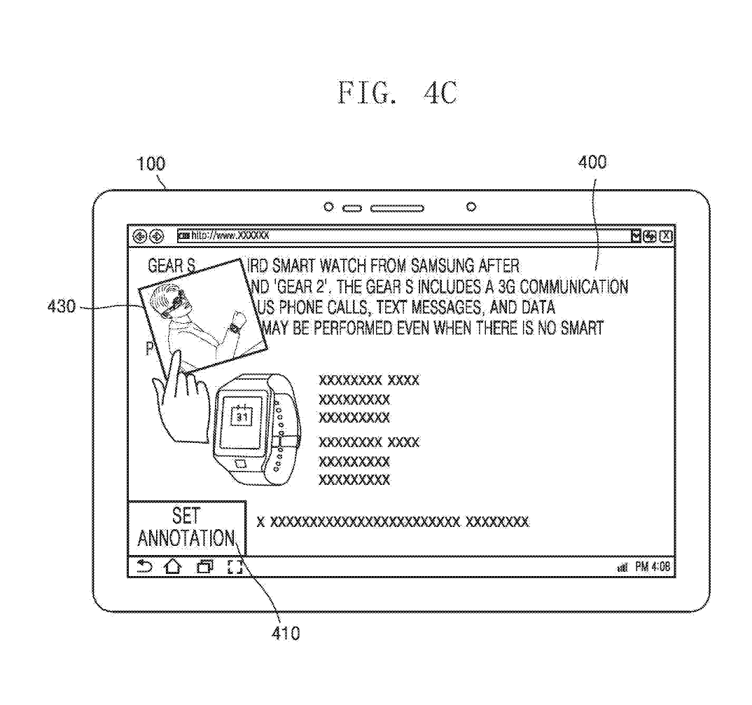

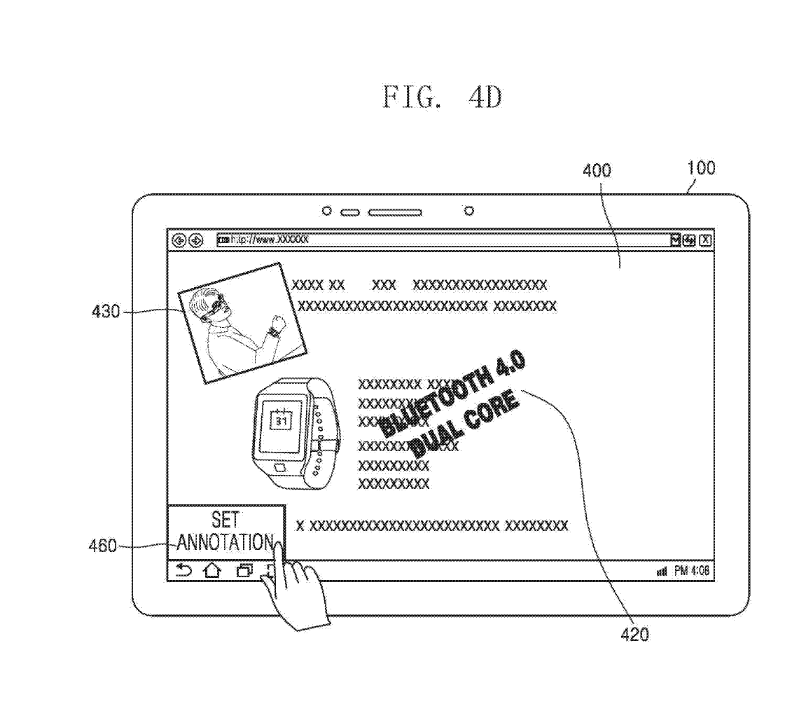

FIGS. 4A through 4D are diagrams showing a method that the device 100 generates an annotation according to a user input, according to an embodiment of the present invention.

Referring to FIG. 4A, the device 100 may receive a user input for selecting an object in content and inputting an annotation for the selected object.

For example, the device 100 may display a web page 400 about “Galaxy Gear”. A user input for selecting a text “Galaxy Gear” in the web page 400 as an object may be received while the web page 400 is being displayed. As the user input for selecting a text is received, the device 100 may display a button 410 for entering an annotation for the selected “Galaxy Gear”. As a user input for selecting the button 410 to enter an annotation for the selected “Galaxy Gear” is received, the device 100 may enter an annotation setting mode.

In the annotation setting mode, when a user input for writing a phrase 420 by using an electronic pen 10 on a display screen is received, the device 100 may display an image generated by a user's handwriting on the display screen.

Referring to FIG. 4B, when a predetermined user input is received while the web page 400 is being displayed, the button 410 for entering the annotation setting mode may be displayed. As a user input for selecting the button 410 to enter the annotation setting mode is received, the device 100 may enter the annotation setting mode.

In the annotation setting mode, the device 100 may receive a voice 440 as an annotation for the web page 400. Furthermore, in the annotation setting mode, the device 100 may photograph an image or an image through a camera provided in the device 100 as an annotation to a web page 400 (450).

Referring to FIG. 4C, in the annotation setting mode, the device 100 may receive a user input for setting an image 430 or a moving picture in content as an annotation for displayed content.

Referring to FIG. 4D, in the annotation setting mode, as a user input for selecting a button 460 for storing an annotation is received, the device 100 may store a set annotation.

For example, in the annotation setting mode, as a predetermined user input is received, the device 100 may display the button 460 for storing an annotation. As a user input for selecting the button 460 for storing the annotation is received, the device 100 may store an annotation as an annotation file.

For example, the device 100 may generate a user's handwritten phrase 420 displayed on a display screen as an image file. Furthermore, the device 100 may store the image 430, which is set on a web page as an annotation, as an image file. In this case, the device 100 may store information regarding location at which an annotation is displayed on a web page along with an annotation file.

Furthermore, the device 100 may generate received voice data as a voice file. In this case, the device 100 may store the information regarding a page displayed on a display screen at a time at which the voice is received, together with the voice file, as information regarding location of an annotation in content. Furthermore, the device 100 may store a photographed image as an image file. Furthermore, photographed video may be generated as a video file.

As an annotation file is generated, the device 100 may determine a tag for the annotation. A tag for an annotation may be identification information regarding content for which the annotation is set. For example, when an annotation is set in “Harry Potter” e-book, a tag thereof may be “Harry Potter”, which is identification information regarding the content to which the annotation is set.

Furthermore, when an annotation is set for a specific object in content, a tag for the annotation may be information regarding the object to which the annotation is set. When the object is a text, the tag for the annotation may be the text itself. For example, in FIG. 4A, a tag for the set annotation 420 may be the text “Galaxy Gear” to which the annotation is set. When the object is an image, the tag for the object may be the identification information regarding the image.

As a tag for an annotation is determined, the device 100 may request the cloud server 1000 to store the annotation corresponding to the tag. In this case, an annotation storage request may include a tag, an annotation file, identification information regarding annotation-set content, storage location information regarding the annotation-set content, information regarding location of the annotation in the content, and an ID of a user registered in the cloud server. Furthermore, in this case, the identification information regarding the annotation-set content, the storage location information regarding the annotation-set content, the information regarding location of the annotation in the content, and the ID of the user registered in the cloud server may be transmitted to the cloud server 1000 as metadata of the annotation file.

As an annotation storage request is received from the device 100, the cloud server 1000 may store an annotation file corresponding to the tag. Furthermore, the cloud server 1000 may store identification information regarding annotation-set content, storage location information regarding the annotation-set content, information regarding location of an annotation in content, and an ID of a user registered in the cloud server 1000 in correspondence to the annotation file.

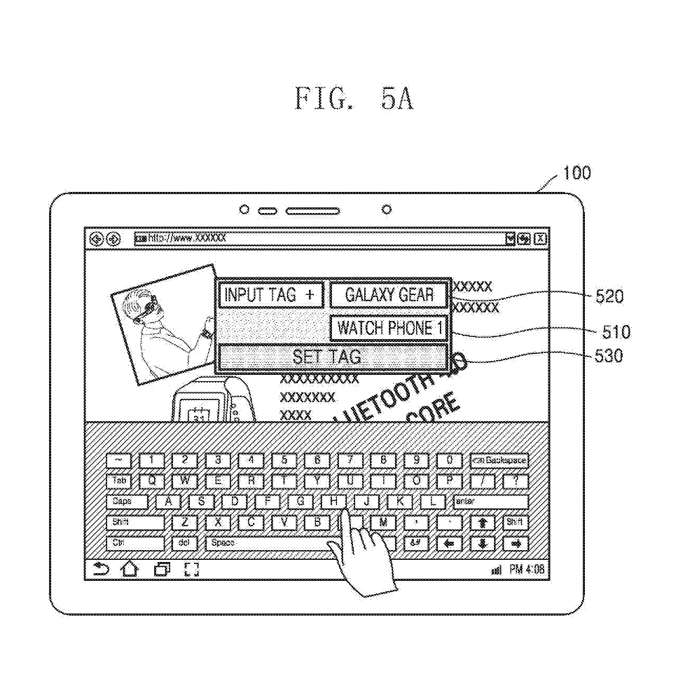

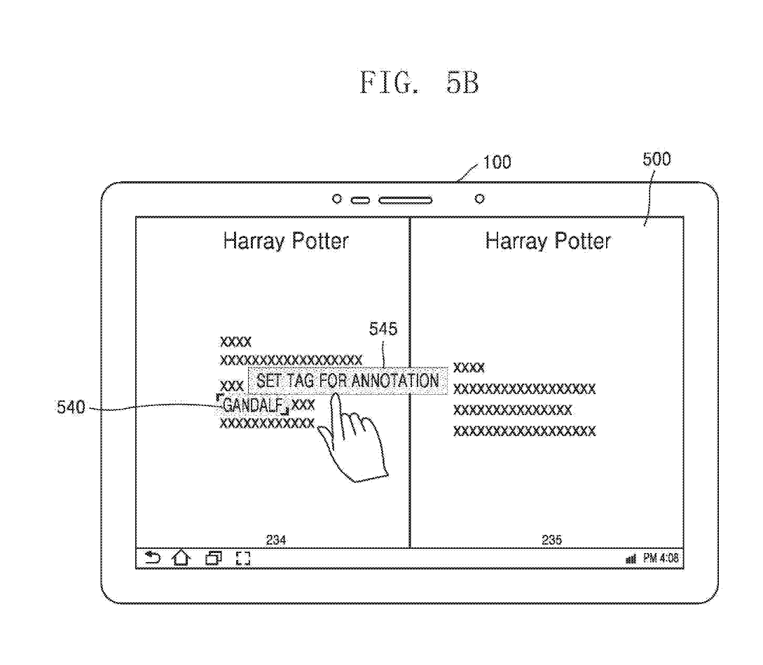

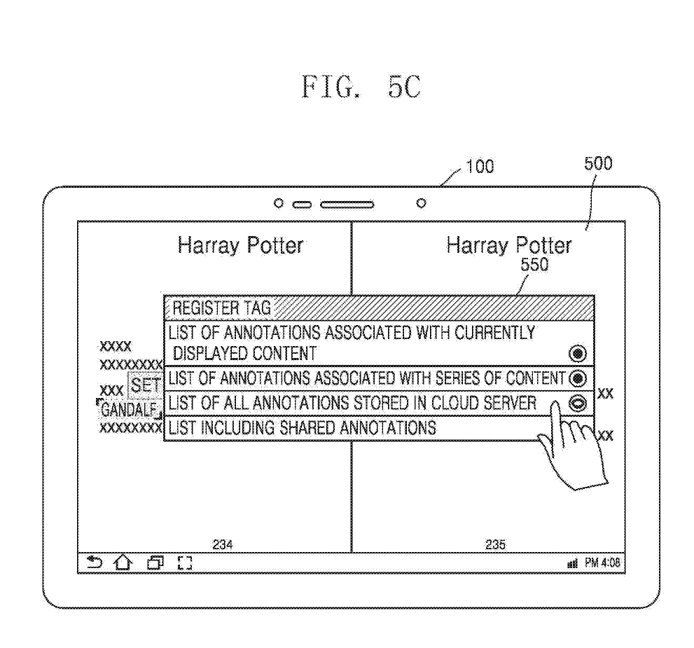

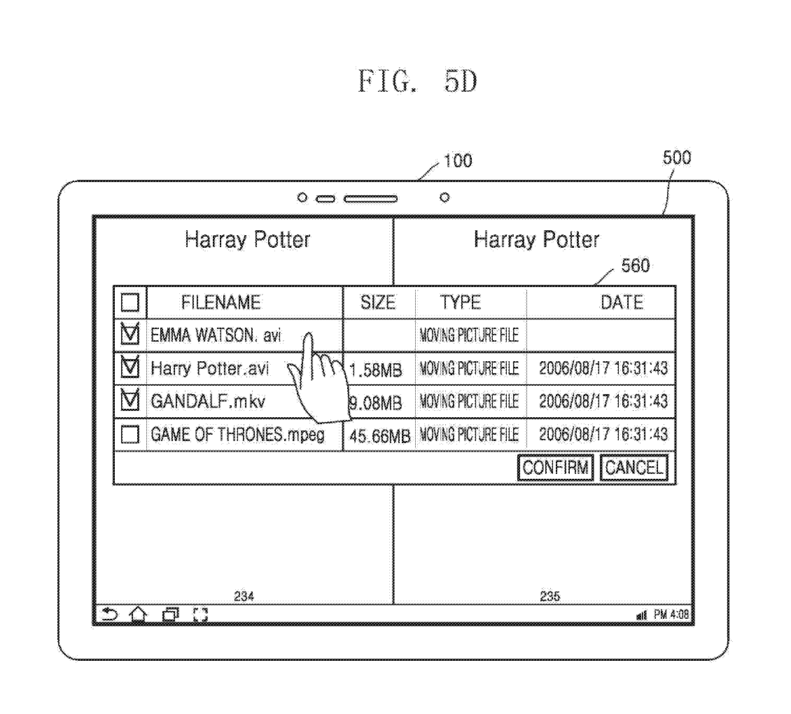

FIGS. 5A through 5D are diagrams for describing a method that the device 100 provides a user interface for inputting a tag for an annotation according to an embodiment of the present invention.

Referring to FIG. 5A, as a user input for selecting the store button 460 of FIG. 4D is received, the device 100 may provide a user interface 510 for entering a tag for an annotation.

The user interface 510 for inputting a tag may include an input field 520 for inputting a tag. The number of input fields for inputting a tag may be adjusted according to a user's selection. As a user input for selecting a tag setting button 530 is received after inputting a tag, the device 100 may store the input tag as a tag corresponding to a set annotation.

Referring to FIG. 5B, the device 100 may provide a user interface for setting a tag for a previously stored annotation.

The device 100 may provide a user interface for selecting an object in content and setting the selected object as a tag for a previously stored annotation.

For example, the device 100 may display a page in a “Harry Potter” e-book 500. Furthermore, when a text “Gandalf” is selected in the page and a predetermined user input is received, the device 100 may display a button 545 for setting the selected text “Gandalf” as a tag for an annotation.

Referring to FIG. 5C, as a user input for selecting the button 545 for setting an annotation is received, the device 100 may provide a user interface for selecting an annotation to set a selected object as a tag therefor. In this case, the device 100 may display a user interface 550 for selecting a range of annotations to search for from among previously stored annotations. For example, the user interface 550 for selecting a range of annotations may include a menu for selecting one of a list of annotations previously stored for currently displayed content, a list of annotations previously stored for series content of the currently displayed content, a list of all annotations stored in a cloud server for a user, and a list of annotations also including annotations shared to the user.

Referring to FIG. 5C, as a user input for selecting a range of annotations is received, the device 100 may display a list of previously stored annotations.

As a user input selecting at least one in a list of annotations is received, the device 100 may request the cloud server 1000 to save the object selected in FIG. 5B as a tag for the selected at least one annotation.

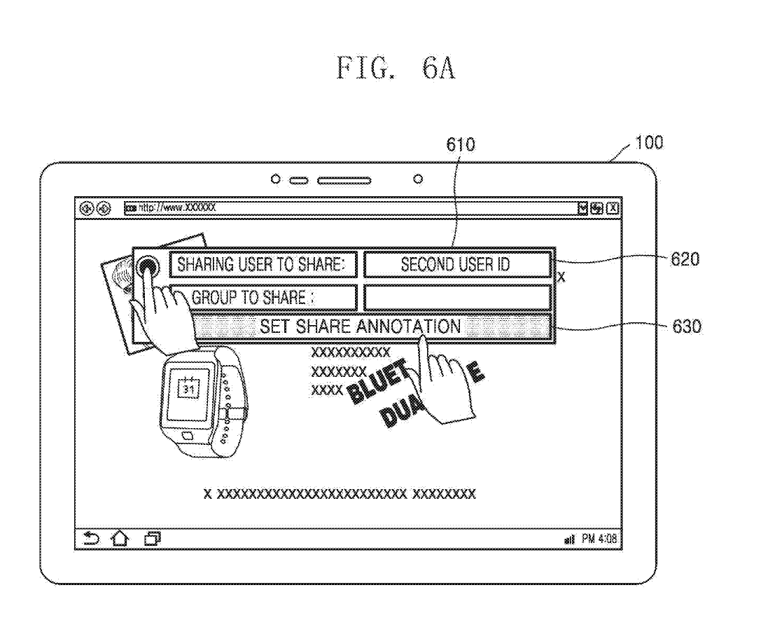

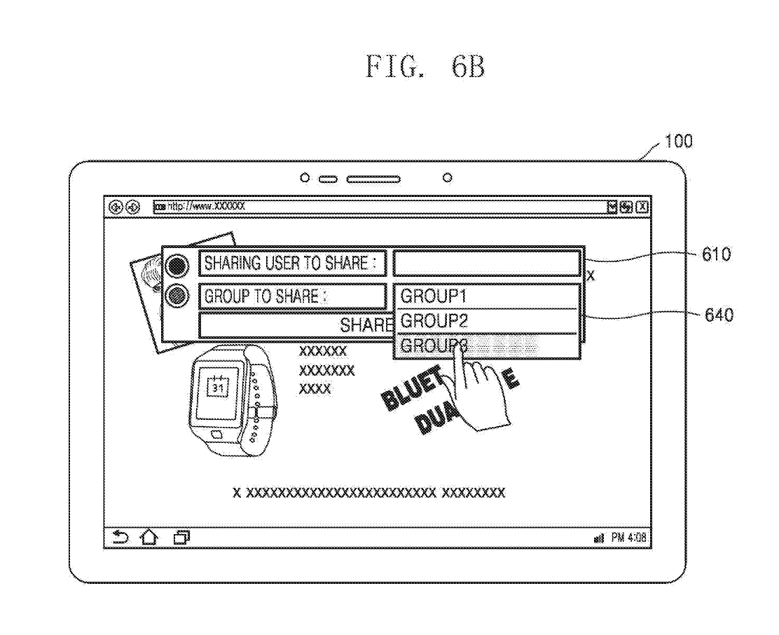

FIGS. 6A and 6B are diagrams for describing a method that the device 100 provides a user interface for setting a sharing user to share an annotation when the device 100 stores an annotation according to an embodiment of the present invention.

Referring to FIG. 6A, the device 100 may provide a user interface for selecting a sharing user to share an annotation.

For example, as a user input selecting the store button of FIG. 4D is received, the device 100 may display a configuration window 610 for selecting a sharing user on a display screen. The device 100 may receive a user input for inputting an ID of a sharing user registered in the cloud server 1000 in an input field 620 in the configuration window 610.

After a user input for inputting a sharing user's ID is received, the device 100, as a user input for selecting an annotation sharing configuration button 630 is received, the device 100 may store a generated annotation file in correspondence to a tag and request the cloud server 1000 to share a corresponding annotation to the selected sharing user.

Referring to FIG. 6B, the device 100 may provide a user interface 640 for selecting a sharing group.

As a user input for selecting a sharing group is received, the device 100 may store a generated annotation file in correspondence to a tag and request the cloud server 1000 to share a corresponding annotation to the input sharing group.

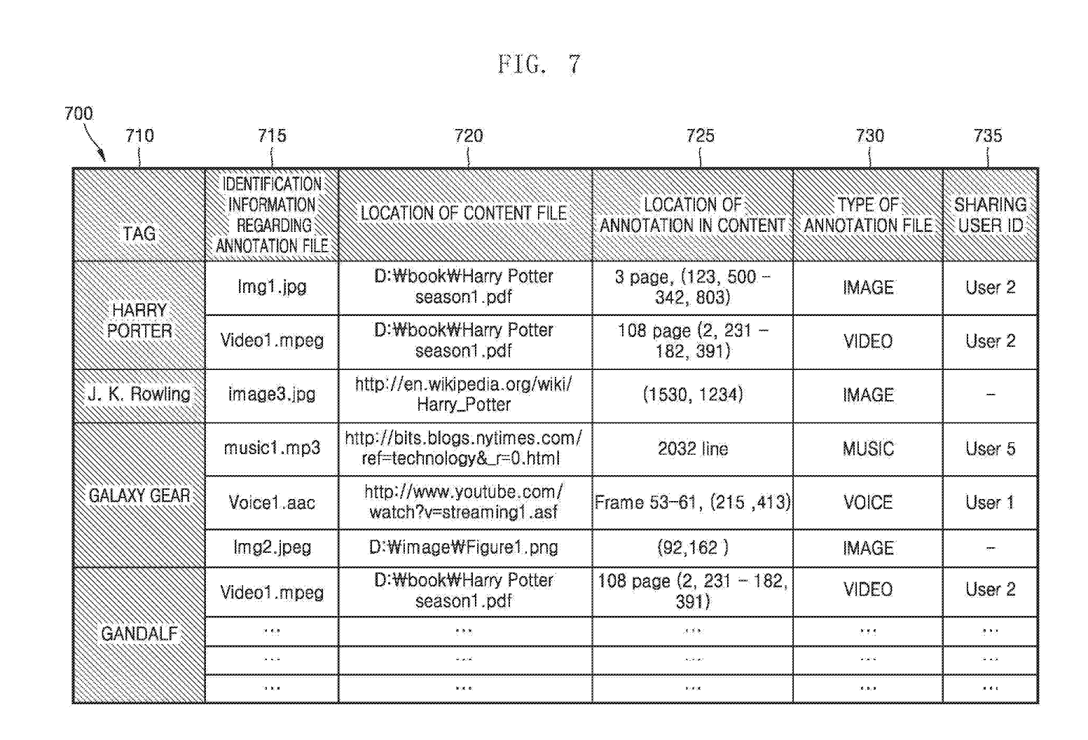

FIG. 7 is a diagram showing a database of annotations stored in the cloud server 1000 according to an embodiment of the present invention.

Referring to FIG. 7, the cloud server 1000 may store annotations in correspondence to tag information.

For example, a database 700 in which an annotation corresponding to tag information is stored may include identification information 715 regarding a annotation file corresponding to a tag 710, storage location information 715 regarding content for which the annotation is set, information 725 regarding location of the annotation in the content, content file type 730, and a sharing user's ID 735.

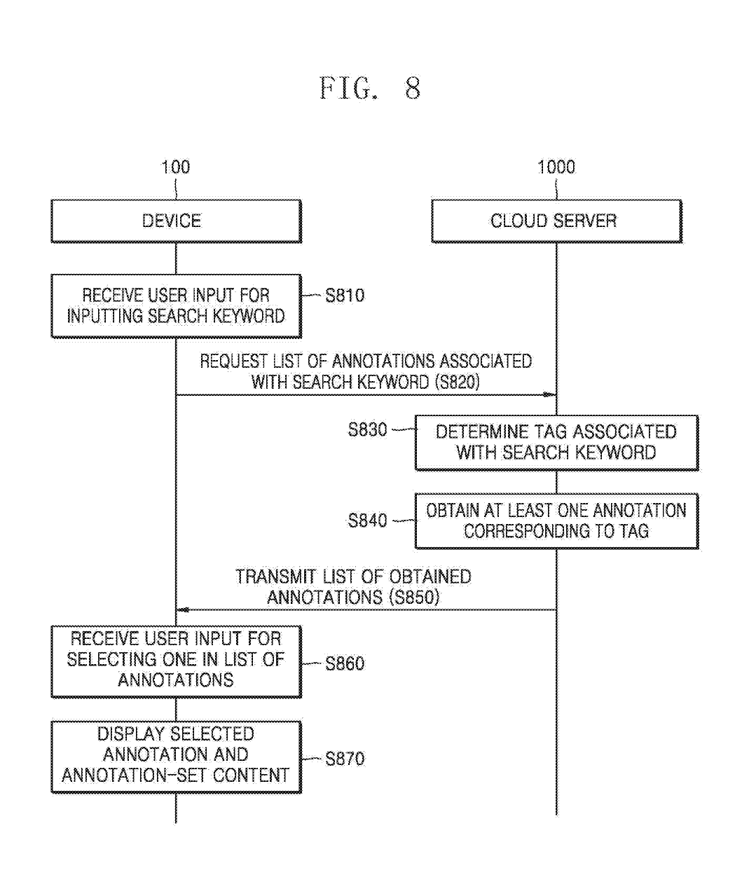

FIG. 8 is a flowchart of a method that the device 100 provides an annotation associated with a search keyword, according to an embodiment of the present invention.

In operation S810, the device 100 may receive a user input for entering a search keyword.

The device 100 may receive a user input that selects one of objects displayed on a display screen as a search keyword. For example, the device 100 may receive a user input that selects one of characters, images, and annotations displayed on the display screen as a search keyword.

Furthermore, the device 100 may provide a search window for inputting a search keyword.

In operation S820, the device 100 may request a list of annotations associated with the search keyword to the cloud server 1000.

As a user input for inputting a search keyword is received, the device 100 may request an annotation associated with the search keyword to the cloud server 1000. An annotation search request may include a search keyword, identification information regarding output content, and the ID of a user registered in the cloud server 1000.

In operation S830, the cloud server 1000 may determine a tag associated with the search keyword.

As the annotation search request is received from the device 100, the cloud server 1000 may determine at least one tag associated with the search keyword. The tag associated with the search keyword may be already determined at the cloud server 1000. For example, related tags may be stored in the cloud server 1000 in correspondence to search keywords. Furthermore, the cloud server 1000 may request and receive a tag associated with a search keyword from an external server.

In operation S840, the cloud server 1000 may obtain at least one annotation corresponding to the determined tag.

As shown in FIG. 7, at least one annotation corresponding to a tag may be stored in the cloud server 1000. Therefore, the cloud server 1000 may obtain at least one annotation corresponding to the determined tag.

In this case, the cloud server 1000 may obtain at least one annotation from among annotations stored in correspondence to the ID of a user. Furthermore, the cloud server 1000 may obtain at least one annotation from among annotations also including annotation shared to the user.

In operation S850, the cloud server 1000 may transmit a list of obtained annotations to the device 100.

As annotations associated with the search keyword is obtained, the cloud server 1000 may transmit a list of the annotations associated with the search keyword to the device 100. Together with the list of the annotations, the cloud server 1000 may transmit a tag, identification information regarding annotation-set content, storage location information regarding the content, information regarding locations of the annotations in content, and an ID of an owner who owns the annotations to the device 100.

In operation S860, the device 100 may receive a user input that selects one in the list of the annotations.

As a list of the annotations associated with the search keyword is received from the cloud server 1000, the device 100 may display the list of the annotations. In this case, in addition to identification information regarding the annotations, the device 100 may also display tags corresponding to the annotations, identification information regarding the content for which the annotations are set, storage location information regarding the content, information regarding locations of the annotations in the content.

The device 100 may receive a user input for selecting one in the displayed list of the annotations.

In operation S870, the device 100 may display a selected annotation and information in the content for which the selected annotation is set.

As a user input for selecting one in the annotation list is received, the device 100 may display a selected annotation and information in the content for which the annotation is set. For example, the device 100 may obtain content based on storage location information regarding the content. Next, the device 100 may display information in the annotation-set content and the set annotation based on information regarding location of the annotation in the content.

For example, when annotation-set content is a moving picture, information regarding location of an annotation in content may be a frame number and coordinate values within the frame. Therefore, the device 100 may display a frame in the moving picture based on the frame number and display the annotation on the frame based on the coordinate values within the frame.

Furthermore, when annotation-set content is a document, information regarding location of an annotation in content may be a page number and coordinate values within the page. Therefore, the device 100 may display a page of a document based on the page number and display an annotation on the page based on the coordinate values within the page.

Furthermore, when annotation-set content is music, information regarding location of an annotation in content may be a playtime. Therefore, the device 100 may simultaneously output audio data of the content and annotation audio data based on the playtime.

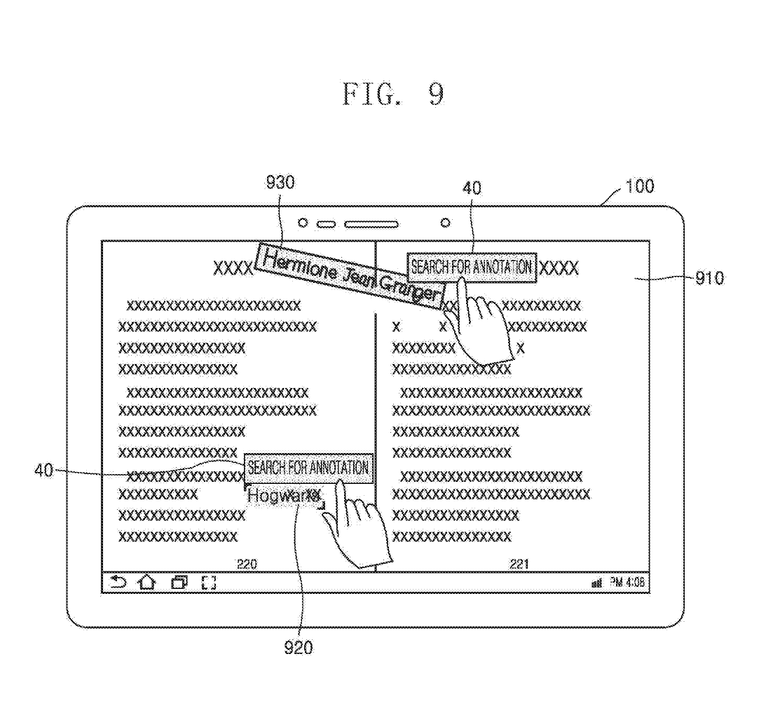

FIG. 9 is a diagram showing a method that a device 100 receives a user input for inputting a search keyword, 2according to an embodiment of the present invention.

Referring to FIG. 9, the device 100 may receive a user input for selecting an object in content as a search keyword.

For example, the device 100 may display a “Harry Potter” e-book 910 that includes a plurality of objects. The plurality of objects may include, for example, characters, images, and annotations in the “Harry Potter” e-book 910.

The device 100 may receive a user input that selects one of a plurality of vocabularies displayed on a display screen. The device 100 may provide a user interface for selecting at least one of the plurality of objects displayed on the display screen as a search keyword.

For example, the device 100 may receive a user input that selects a text “Hogwarts” 920 among a plurality of letters in a “Harry Potter” e-book 910 displayed on the display screen. As a user input for selecting an object is received, the device 100 may highlight the selected object to indicate that it is a text selected by a user.

When a predetermined user input is received after an object is selected, the device 100 may display an annotation search button 40. For example, when a long touch input is received after a vocabulary is selected, the device 100 may display the annotation search button 40.

As a user input for selecting the annotation search button 40 is received, the device 100 may determine the selected object as a search keyword. For example, the device 100 may determine the text “Hogwarts” 920 as a search keyword.

Furthermore, as a user input for selecting an annotation “Hermione Jean Granger” 930 displayed on the display screen and selecting the annotation search button 40 is received, the device 100 may determine the selected annotation 930 as a search keyword.

As the selected object is determined as a search keyword, the device 100 may request the cloud server 1000 to search for an annotation associated with the selected object. In this case, the annotation search request may include the selected object, identification information regarding content, and an ID of a user registered in the cloud server 1000. For example, in FIG. 9, the device 100 may request the cloud server 1000 to search for an annotation by using the selected object “Hogwarts” or “Hermione Jean Granger” as a search keyword. In this case, the device 100 may transmit not only the selected object, but also “Harry Potter”, which is the ID of content, and an ID of a user registered in the cloud server 1000 to the cloud server 1000.

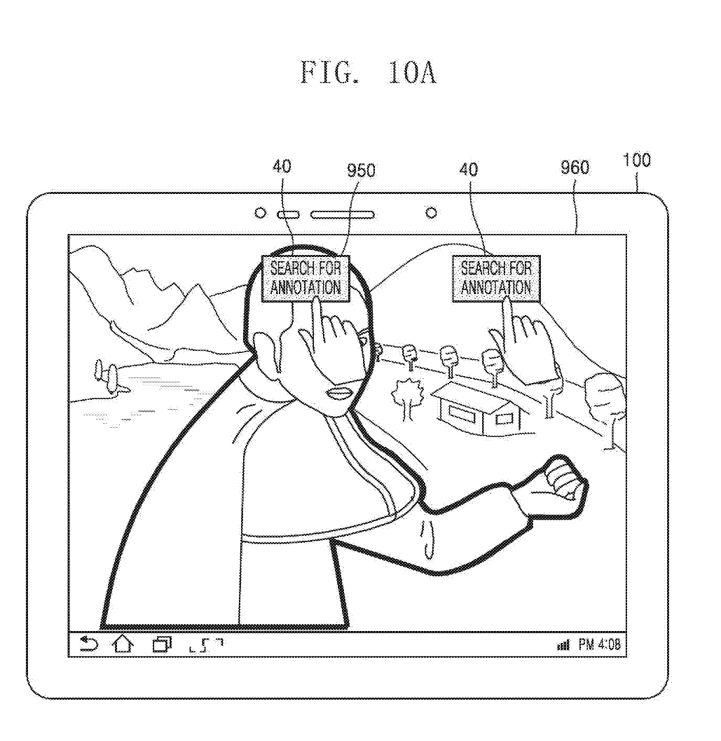

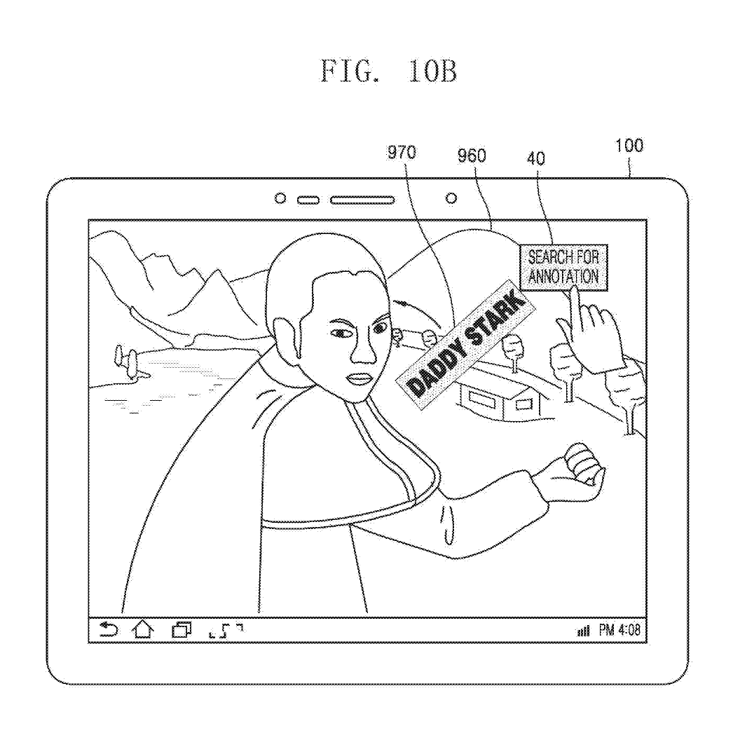

FIG. 10A is a diagram showing a method that the device 100 receives a user input for inputting a search keyword, when content is a moving picture, according to an embodiment of the present invention.

Referring to FIG. 10A, the device 100 may receive a user input for inputting an object in a moving picture frame 960 as a search keyword.

For example, while a video playback is being paused, the device 100 may receive a user input for selecting an object in the frame 960 displayed on the display screen.

Information regarding an object in the frame 960 may be recorded in a moving picture file. An object in the frame 960 may include a person or object represented by frame 960. Furthermore, the information regarding the object in the frame 960 may include identification information regarding the object.

For example, identification information regarding an object may include an actual name of a person and an actual name of an object. Furthermore, identification information regarding an object may refer to a name of the object determined in content. For example, the actual name of an object 950 shown in FIG. 10A may be “Sean Bean”, and the name of the object 950 in content may be “Ned Stark”.

As a user input for selecting the object 950 in the frame 960 displayed on the display screen is received, the device 100 may display the annotation search button 40 for determining the selected object 950 as a search keyword. As a user input for selecting the annotation search button 40 is received, the device 100 may determine the selected object 950 as a search keyword.

As the selected object 950 is determined as a search keyword, the device 100 may request the cloud server 1000 to search for an annotation associated with the selected object 950. In this case, the annotation search request may include identification information regarding content, identification information regarding the selected object, and an ID of a user registered in the cloud server 1000. For example, in FIG. 10A, identification information regarding content may be “Game of Thrones season 1.avi”, and identification information regarding a selected object may be “Sean Bean” or “Ned Stark”.

Furthermore, while a video playback is being paused, as a user input for selecting the frame 960 displayed on the display screen is received, the device 100 may display the search button 40 for determining the selected frame 960 as a search keyword. As a user input for selecting the annotation search button 40 is received, the device 100 may determine the selected frame 960 as a search keyword.

As the selected frame 960 is determined as a search keyword, the device 100 may request the cloud server 1000 an annotation associated with the selected frame 960. In this case, the annotation search request may include identification information regarding content and a frame number or playtime information regarding the selected frame 960. Furthermore, the annotation search request may include information regarding an object in the frame 960.

FIG. 10B is a diagram showing a method that a device 100 receives a user input for inputting a search keyword, when content is a moving picture, according to another embodiment of the present invention.

Referring to FIG. 10B, the device 100 may provide a user interface for setting an annotation 970 in a moving picture frame 960 as a search keyword.

For example, the device 100 may display the frame 960 in a moving picture and the annotation 970 input onto the frame 960 during playback of the moving picture. The annotation 970 input onto the frame 960 may be an annotation previously input by a user in correspondence to the frame 960.

As a user input for pausing playback of the moving picture is received and a user input for selecting the annotation 970 displayed on the display screen is received, the device 100 may display the annotation search button 40. As a user input for selecting the annotation search button 40 is received, the device 100 may determine the selected annotation 970 as a search keyword.

As the selected annotation 970 is determined as a search keyword, the device 100 may request the cloud server 1000 an annotation associated with the selected annotation 970. In this case, the annotation search request may include identification information regarding content, identification information regarding the annotation 970, and information regarding location of the annotation 970 in content.

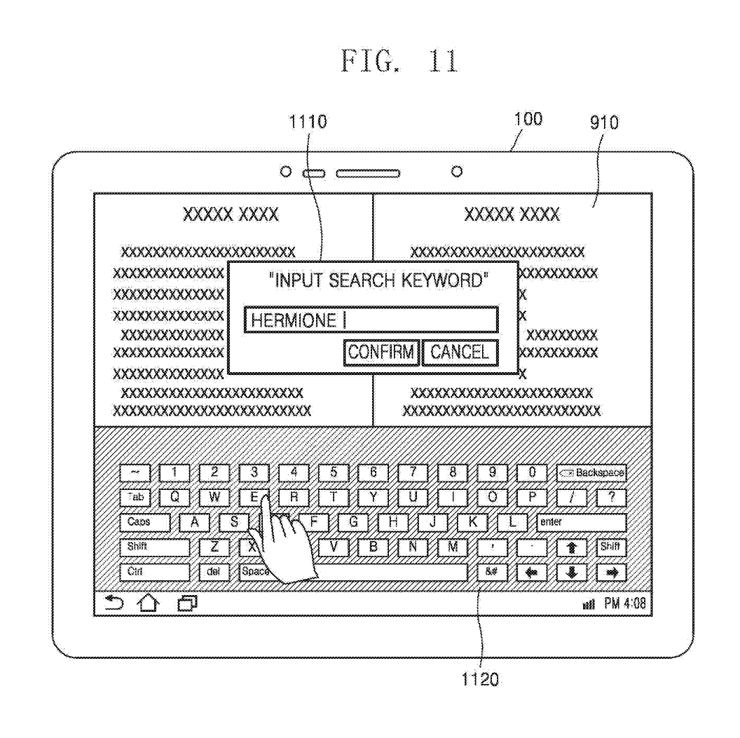

FIG. 11 is a diagram showing a method that the device 100 receives a user input for inputting a search keyword through a search window, according to an embodiment of the present invention.

Referring to FIG. 11, the device 100 may provide a search window for inputting a search keyword.

For example, when a pre-set user input is received while the e-book 20 is being displayed, the device 100 may display a search window 1110 and an on-screen keyboard 1120 for inputting a text in the search window 1110.

As a user input for inputting a text in the search window 1110 and pressing Confirm is received, the device 100 may determine the input text as a search keyword. As the search keyword is determined, the device 100 may request the cloud server 1000 to search for an annotation associated with the input text.

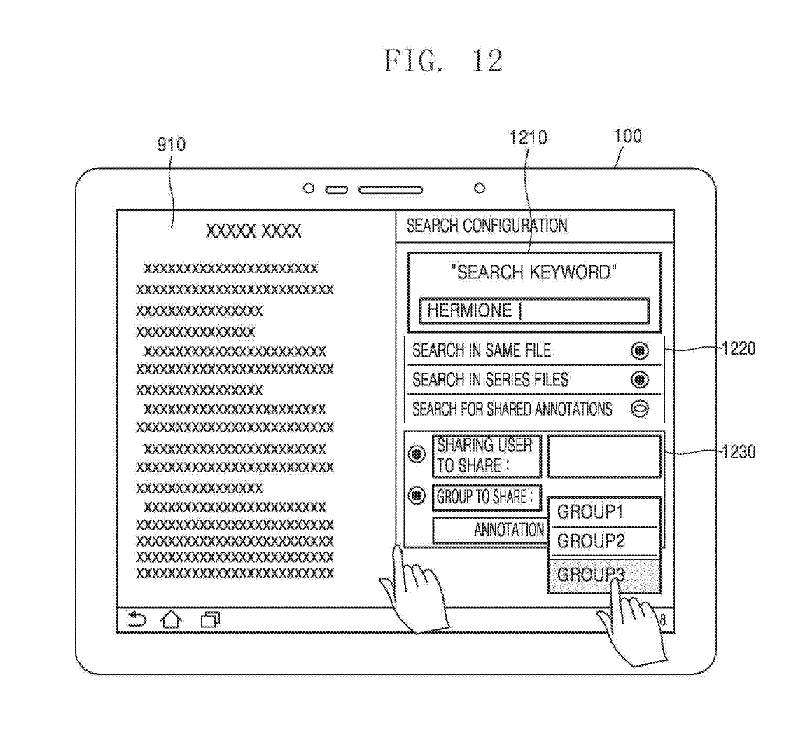

FIG. 12 is a diagram showing a method that the device 100 receives a user input for inputting a search keyword through a search window, according to another embodiment of the present invention.

Referring to FIG. 12, the device 100 may provide a user interface for configuring search conditions.

For example, while the e-book 910 is being displayed, as a user input for pushing a display screen is received, the device 100 may display a page for configuring search conditions.

The page for setting search conditions may include an input field 1210 for inputting a search keyword.

Furthermore, the page for setting the search condition may include a radio button 1220 for setting an annotation search range. The annotation search range may include whether to search within a currently displayed content, whether to search within a same series file as the currently displayed content, and whether to search for annotations also in annotations of other users shared to the user.

As a user input that selects to search for all of annotations of other users shared to a user is received, the device 100 may display a user interface 1230 for selecting a sharing user or a sharing group.

As a user input that selects a sharing user or a sharing group and selects an annotation search button through the user interface 1230 that allows a sharing user or a sharing group to be selected is received, the device 100 may request an annotation with an input text from among annotations of a selected sharing user or a selected sharing group.

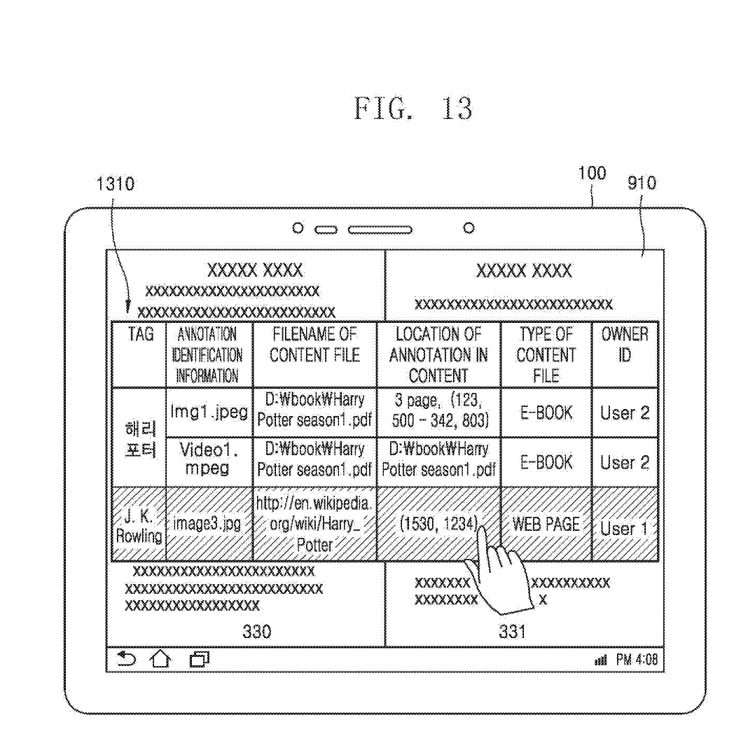

FIG. 13 is a diagram showing a method that a device 100 provides a list of annotations associated with a search keyword, according to an embodiment of the present invention.

Referring to FIG. 13, the device 100 may receive a list of annotations associated with a search keyword from the cloud server 1000 and may display the received list of annotations.

For example, the device 100 may receive a list of annotations associated with a search keyword “Hermione” from the cloud server 1000 by requesting an annotation associated with the search keyword “Hermione” to the cloud server 1000. For example, in the cloud server 1000, “Harry Potter” and “J.K. Rowling” may be determined in advance as associated tags.

As a tag associated with a search keyword is obtained, the cloud server 1000 may determine an annotation corresponding to the tag. For example, the cloud server 1000 may obtain annotations corresponding to “Harry Potter”, “J.K. Rowling” from a stored database of annotations stored in correspondence to tags shown in FIG. 7. Next, the cloud server 1000 may transmit a list of determined annotations to the device 100. Furthermore, the cloud server 1000 may transmit to the device 100 not only a list of the annotations, but also a tag, identification information regarding annotation-set content, storage location information regarding content, location information regarding location of annotation in the content, and an ID of a user owning the annotation.

The device 100 may display a list 1310 of annotations received from the cloud server 1000. Furthermore, the device 100 may displays not only the list of annotations, but also tags, identification information regarding annotations, identification information regarding annotation-set content, storage location information regarding content, information regarding locations of annotations in content, and IDs of owners that own annotations.

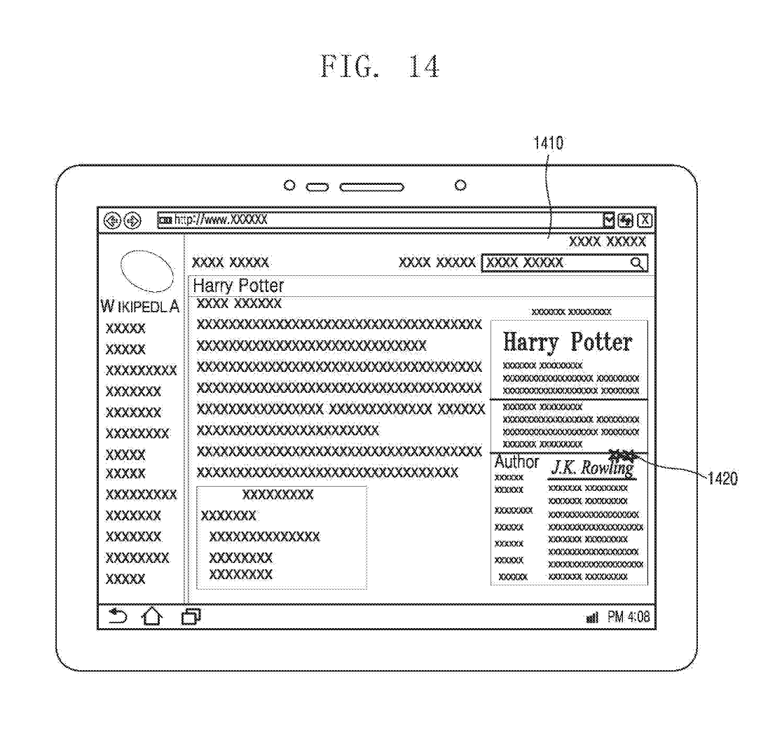

FIG. 14 is a diagram showing a method that the device 100 displays an annotation selected by a user from among annotations found based on a search keyword, according to an embodiment of the present invention.

Referring to FIG. 14, as a user input for selecting one in the list of annotations is received, the device 100 may display the selected annotation and information in the annotation-set content. For example, the device 100 may obtain content based on storage location information regarding the content. Next, the device 100 may display information in the annotation-set content and the set annotation based on the information regarding location of an annotation in the content.

For example, in FIG. 13, as a user input for selecting a web page regarding “J.K. Rowling” from a list of annotations associated with “Hermione” is received, the device 100 may display a web page 1410 regarding “J.K. Rowling”. In this case, the device 100 may execute a web browser based on the type (web page) of content for which a selected annotation is set and display the web page regarding “J.K. Rowling” based on the filename (http://en.wikipedia.org/wiki/Harry Potter) of a content file in which an annotation is located. Furthermore, the device 100 may display an annotation 1420 selected on the web page 1410 regarding “J.K. Rowling”.

In this case, the device 100 may adjust the displayed location of the web page 1410 based on information regarding location of an annotation in the web page, such that the annotation 1420 may be displayed.

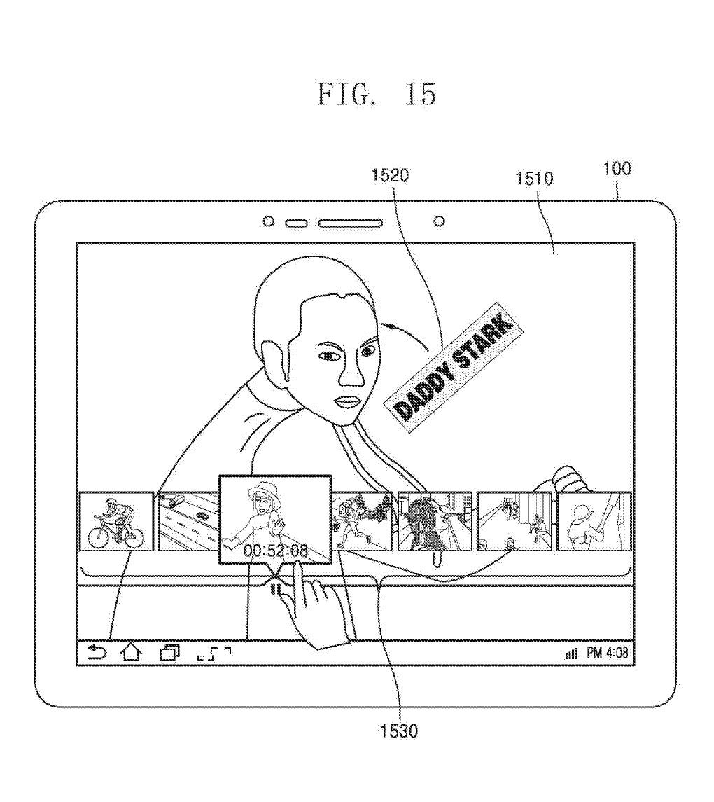

FIG. 15 is a diagram showing a method of displaying an annotation selected by a user from among annotations found based on a search keyword, according to another embodiment of the present invention.

Referring to FIG. 15, the device 100 may display a frame of a moving picture file in which an annotation is located, as a user input for selecting an annotation in the video frame from a list of annotations is received.

For example, when a selected annotation is located in a frame in a moving picture, the device 100 may obtain the moving picture based on storage location information regarding the moving picture. Furthermore, based on the type of content, the device 100 may execute a moving picture player for playing back the moving picture. Furthermore, based on information regarding location of an annotation in content, the device 100 may decode a frame 1510 in which a selected annotation 1520 is located and display the annotation 1520 on the decoded frame 1510.

Furthermore, when a plurality of annotations located in a plurality of frames in a same moving picture are selected, the device 100 may display thumbnails 1530 of frames in which the selected annotations are located.

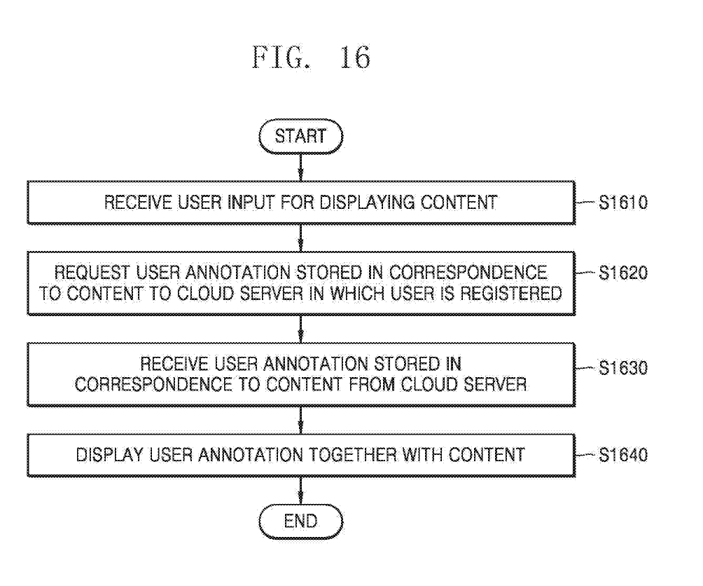

FIG. 16 is a flowchart of a method that a device 100 provides an annotation of a user corresponding to content, as a user input for displaying the content is received, according to an embodiment of the present invention.

In operation S1610, the device 100 may receive a user input for displaying content.

The content may include an electronic document, an e-book, an image, a moving picture, or a web page.

In operation S1620, the device 100 may request an annotation of a user stored in correspondence to content to the cloud server in which a user is registered.

The annotation request may include identification information regarding content and an ID of a user registered in the cloud server 1000. The identification information regarding content may include, but is not limited to, a filename, an URI, and an IS4N number of the content.

In operation S1630, the device 100 may receive an annotation of a user stored in correspondence to content from the cloud server 1000.

The device 100 may request an annotation of a user stored in correspondence to content to the cloud server 1000.

In response to the annotation request, the device 100 may receive an annotation file, storage location information regarding annotation-set content, identification information regarding the annotation-set content, information regarding location of an annotation in the content, the type of the annotation file, and an ID of a sharing user registered in the cloud server 1000, from the cloud server 1000.

In operation S1640, the device 100 may display an annotation of a user together with content.

The device 100 may display an annotation of a user together with annotation-set content.

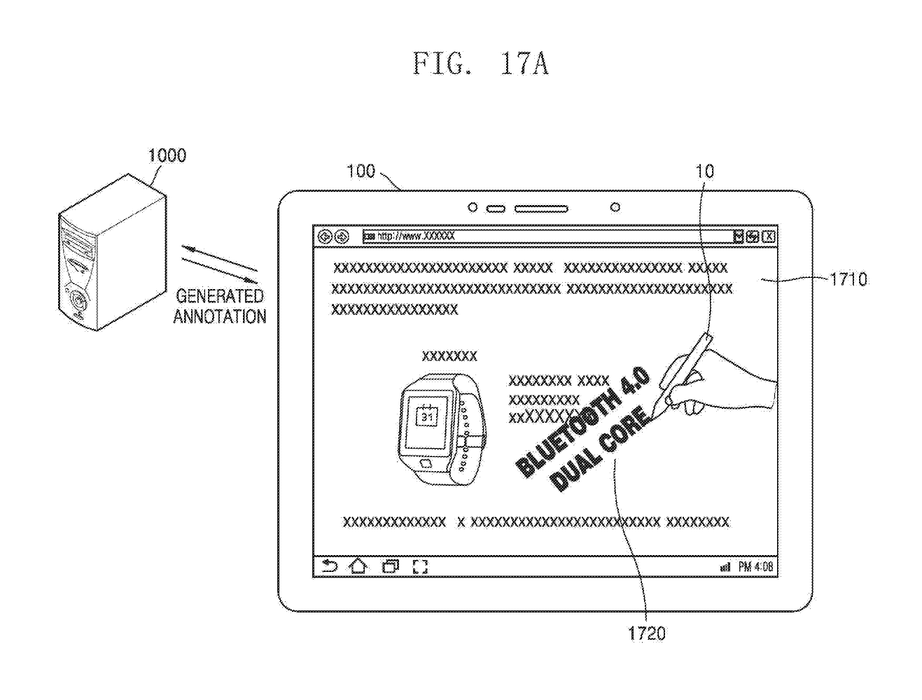

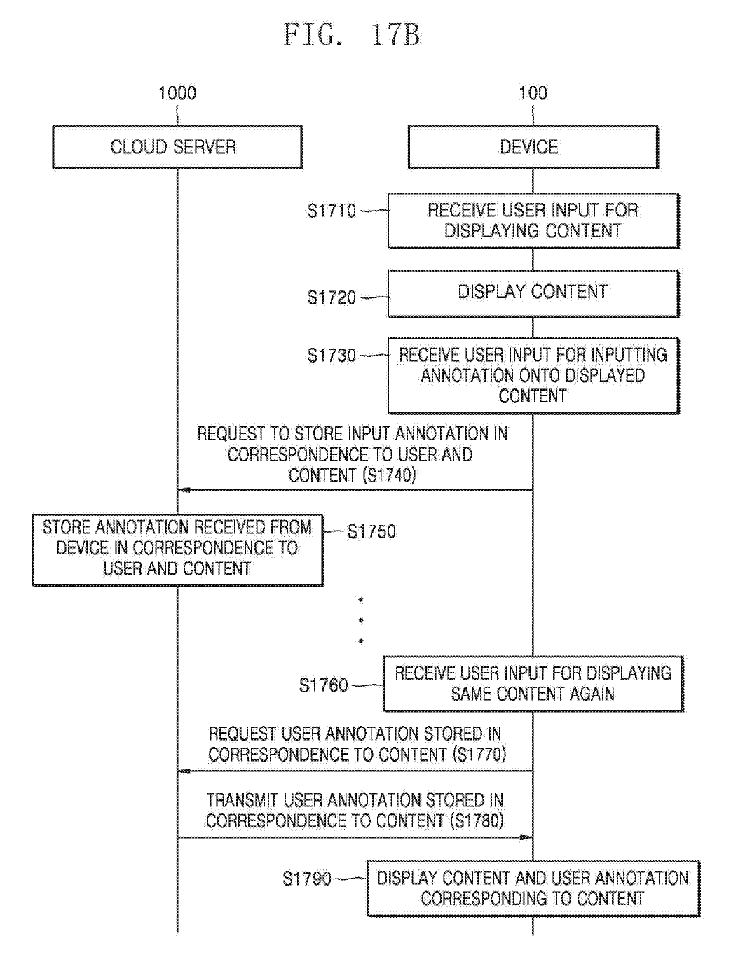

FIG. 17A is a diagram of a method that the device 100 provides an annotation, according to an embodiment of the present invention.

Referring to FIG. 17A, the device 100 may receive a user input for setting an annotation in content and store the set annotation in correspondence to the content.

For example, a web browser application in the device 100 may generate a web page 1710 by rendering a web page file and display the generated web page 1710 on the display screen. The device 100 may receive a user input for inputting an annotation onto the web page 1710 displayed on the display screen. For example, the device 100 may receive a user input for inputting an annotation onto a touch screen by using an electronic pen 10.

The device 100 may request the cloud server 1000 to update annotations set for the web page 1710 in correspondence to a user and the web page 1710.

For example, when an annotation input by a user with respect to the web page 1710 is a phrase “Bluetooth 4.0, dual core” 1720, the device 100 may generate the phrase “Bluetooth 4.0, dual core” 1720 as a text file or an image file. Furthermore, the device 100 may calculate the coordinates of the phrase “Bluetooth 4.0, dual core” 1720 based on the web page 1710 and determine the calculated coordinate values as information regarding location of an annotation in content.

As an annotation file is generated, the device 100 may request the cloud server 1000 to store the generated annotation file in correspondence to a user and the web page 1710. The annotation storage request may include not only the annotation file, but also a URL address of a web page as storage location information regarding the annotation-set content or identification information regarding the annotation-set content. Furthermore, the annotation storage request may include coordinate values of the phrase “Bluetooth 4.0, dual core” 1720 as information regarding location of an annotation in content. Furthermore, the annotation storage request may include information indicating the type of the annotation file. Furthermore, the annotation storage request the cloud server 1000 the ID of a user registered in the cloud server 1000 and an ID of a sharing user registered in the cloud server 1000.

As an annotation storage request is received from the device 100, the cloud server 1000 may store an annotation and information regarding the annotation in correspondence to a URL address of the web page 1710 and an ID of a user.

As a user input for displaying the annotation-set web page 1710 is received after a web browser application is terminated, the device 100 may request the cloud server 1000 an annotation corresponding to the web page 1710. The annotation request may include the URL address of a web page and an ID of a user registered in the cloud server 1000.

As the annotation request is received, the cloud server 1000 may obtain annotation files and information regarding the annotations corresponding to the web page 1710 and a user based on a URIL address and the ID of the user. The annotation stored in correspondence to the URL address of the web page 1710 and the ID of the user may be the phrase “Bluetooth 4.0, dual core” 1720 input by a user onto the web page 1710. The cloud server 1000 may transmit information regarding the obtained annotation file and the annotation to the device 100.

The device 100 may execute an annotation file based on the type of the annotation file. For example, when the type of an annotation file is an image file, the device 100 may decode the image file to generate an image indicating “Bluetooth 4.0, Dual Core”.

Furthermore, based on information regarding location of an annotation in a web page, the web page may be displayed to include an image indicating “Bluetooth 4.0, dual core” on the web page.

FIG. 17B is a flowchart of a method of that the device 100 provides an annotation by using the cloud server 1000 according to an embodiment of the present invention.

In operation S1710, the device 100 may receive a user input for displaying content.

The content may include, but is not limited to, a document, a voice, an image, a video, and a web page.

In operation S1720, the device 100 may display content.

In operation S1730, the device 100 may receive a user input for inputting an annotation onto the displayed content.

The device 100 may receive a user input for inputting an annotation. An annotation may include, but is not limited to, a handwriting, a text, a voice, an image, and a video. For example, the device 100 may receive a touch input of a user for inputting an annotation onto a web page displayed on the display screen. The device 100 may also receive a user input for recording a voice.

In operation S1740, the device 100 may request the cloud server 1000 to store the input annotation in correspondence to a user and content.

As the user input for storing an annotation received, the device 100 may generate an input annotation as an annotation file. For example, the device 100 may generate an input annotation in the form of a text file, an image file, a voice file, and a video file.

As the input annotation is generated as an annotation file, the device 100 may request the cloud server 1000 to store the annotation in accordance to a user and content.

The annotation storage request may include an annotation file and information regarding an annotation. The information regarding the annotation may include at least one of storage location information regarding annotation-set content, identification information regarding annotation-set content, information regarding location of an annotation in content, the type of the annotation file, an ID of the ID of a user registered in the cloud server 1000, However, the present invention is not limited thereto.

The identification information regarding content may include, but is not limited to, a filename, an URI, and an IS4N number of the content. When the device 100 transmits an input annotation to the cloud server 1000 in the form of a file, the device 100 may record annotation information to the metadata of an annotation file.

In operation S1750, the cloud server 1000 may store an annotation received from the device 100 in correspondence to a user and content.

Furthermore, the cloud server 1000 may store an annotation file received from the device 100 in correspondence to a user ID. Furthermore, the cloud server 1000 may store an annotation file received from the device 100 in correspondence to identification information regarding content. Furthermore, the cloud server 1000 may store annotation information together with an annotation file.

In operation S1760, the device 100 may receive a user input for displaying a same content again.

For example, the device 100 may receive a user input for terminating displaying of an annotation-set content and displaying the same content again.

In operation S1770, the device 100 may request an annotation of a user stored in correspondence to content to the cloud server 1000.

The annotation request may include identification information regarding content and an ID of a user registered in the cloud server 1000.

In operation S1780, the cloud server 1000 may transmit an annotation of the user stored in correspondence to content to the device 100.

The cloud server 1000 may obtain an annotation of a user corresponding to the user and content based on the ID of a user and identification information regarding the content received from the device 100.

The cloud server 1000 may transmit an annotation of a user stored in correspondence to obtained content to the device 100. For example, the cloud server 1000 may transmit information regarding a user annotation file and information regarding an annotation stored in correspondence to the obtained content to the device 100.

In operation S1790, the device 100 may display content and an annotation of a user stored in correspondence to the content.

As an annotation is received from the cloud server 1000, the device 100 may display content and an annotation of a user corresponding to the content.

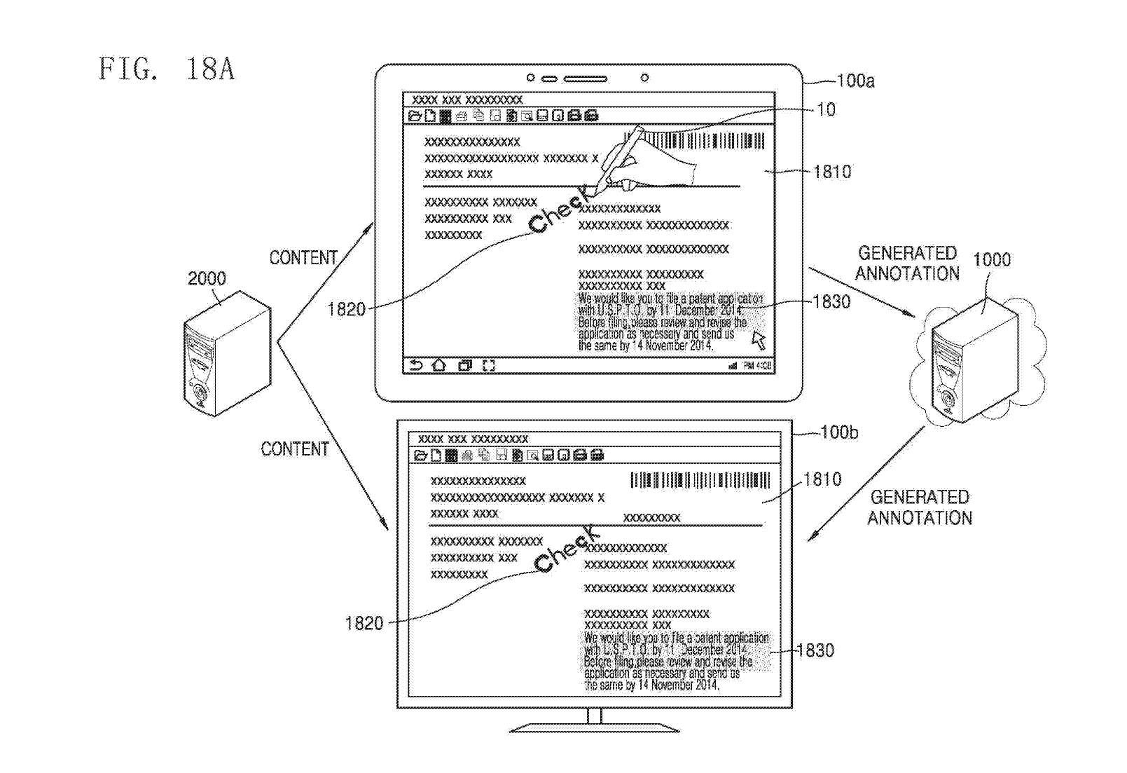

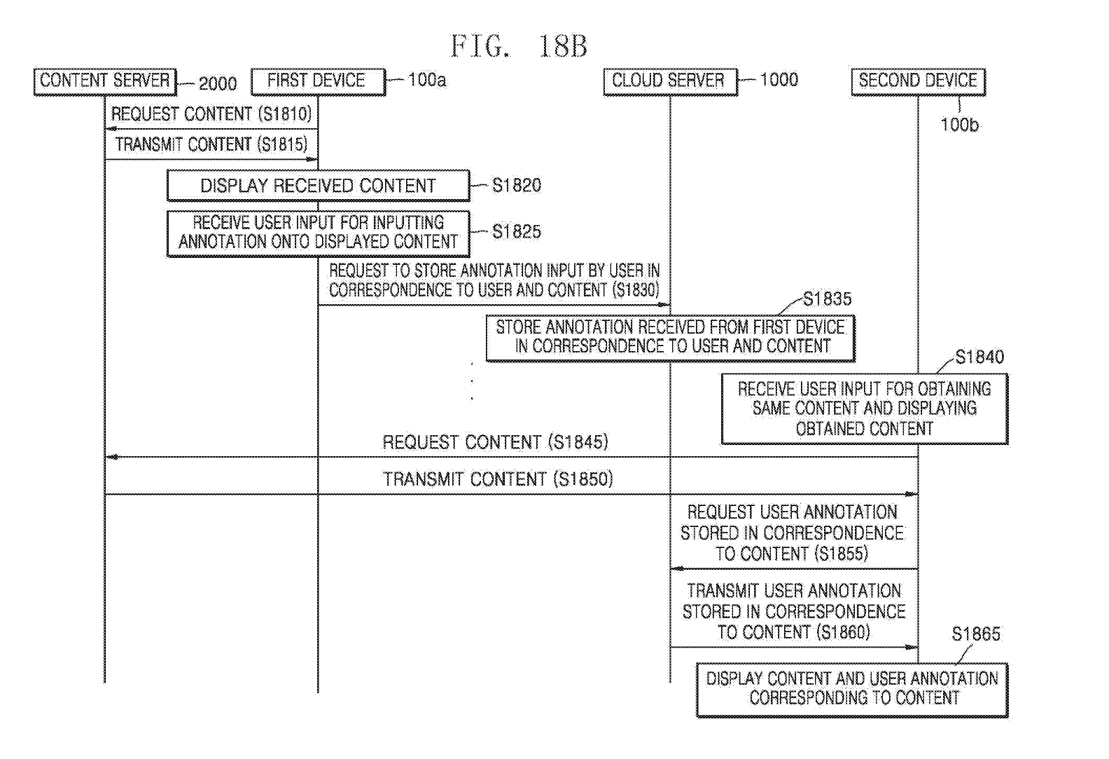

FIG. 18A is a diagram showing a method that a plurality of devices 100 of a user provide annotations, according to an embodiment of the present invention.

Referring to FIG. 18A, a first device 100a of the user may request the cloud server 1000 to store an annotation input for content in correspondence to the content and the user. Furthermore, as a user input for displaying the same content is received, a second device 100b of the user may receive an annotation corresponding to the content from the cloud server 100 and display the content and the annotation corresponding to the content.

A PDF viewer in the first device 100a may display PDF content 1810 received from a content server. Furthermore, the first device 100a may receive a user input for inputting an annotation onto the PDF content 1810 displayed on the display screen. For example, the first device 100a may receive a user input for writing a phrase 1820 on a touch screen by using the electronic pen 10. Furthermore, the first device 100a may also receive a user input for selecting an object 1830 in the PDF content 1810 by using the PDF viewer's document editing function and an inputting underlines, notes, highlights, etc., for the selected object 1830.

The first device 100a may generate an annotation input onto the PDF content 1810 as an annotation file and determine information regarding location of the annotation in content.

For example, when an annotation input by a user for the PDF content 1810 is a phrase “check” 1820, the first device 100a may generate the phrase “check” 1820 as a text file or an image file. Furthermore, when the object 1830 in the PDF content 1810 is highlighted, a file indicating that there is the highlighted object 1830 may be generated.

Furthermore, the first device 100a may calculate location of an annotation input to the PDF content 1810 and may determine calculated coordinate values as information regarding location of the annotation in content. For example, the display position of the phrase “check” 1820 may be “page 1, 230, 150”. Furthermore, location of the highlighted portion 1830 of the text in the PDF content 1810 may be “page 1, from 1 char of line 3, 1 char to 20 char of line 5”.

As an annotation file is generated and location of an annotation in content is determined, the device 100 may request the cloud server 1000 to store the annotation input to the PDF content 1810 in response to a user and the PDF content 1810.

In addition to a generated annotation file, the device 100 may store the filename of the PDF content 1810, the unique code of the PDF content 1810, information regarding location of an annotation in content, and an ID of a user registered in the cloud server 1000 to the cloud server 1000.

As the annotation file and information regarding an annotation are received from the first device 100a, the cloud server 1000 may store the annotation file and the information regarding the annotation in correspondence to identification information regarding content and an ID of a user.

The user's second device 100b may receive the same PDF content 1810 from the content server as a user input for displaying the same content as the PDF content 1810 for which an annotation is input in the first device 100a is received. For example, after a user clicks a link in a web page at the first device 100a and receives the PDF content 1810 from a web server, the same PDF content 1810 may be received from the web server by clicking a link in a same web page at the second device 100b.

Furthermore, the user's second device 100b may request an annotation of a user stored in correspondence to the PDF content 1810 to the cloud server 1000. In this case, the annotation request may include the filename of the PDF content 1810 as identification information regarding the PDF content 1810 or the unique code of the PDF content 1810 and an ID of a user registered in the cloud server 1000.

The cloud server 1000 may obtain a annotation stored in correspondence to identification information regarding the PDF content 1810 received from the second device 100b and an ID of a user. The annotation stored in correspondence to the identification information regarding the PDF content 1810 and the ID of the user may be an image file indicating the phrase “check” input by the user for the PDF content 1810 in the first device 100a or may be an information file that highlights some of the text in the PDF content 1810.

The cloud server 1000 may transmit the obtained annotation to the second device 100b as the annotation corresponding to the identification information regarding the PDF content 1810 and the ID of the user is obtained. In this case, the cloud server 1000 may transmit information regarding location of the annotation in the PDF content 1810, along with the annotation file, to the second device 100b.

The second device 100b may display the PDF content 1810 and the annotation 1820, such that an annotation is displayed at the position where the user input the annotation, based on the information regarding location of the annotation in the PDF content 1810. For example, when the displaying location of the phrase “check” 1820 is “page 1, 230, 150”, the second device 100b may display an image indicating the phrase “check ” 1820 on the PDF content 1810 based on the location “page 1, 230, 150”.

FIG. 18B is a flowchart of a method that the plurality of devices 100 of a user provide annotations, according to an embodiment of the present invention.

In operation S1810, the first device 100a may request content from a content server.

The content may include, but is not limited to, documents, voices, images, images, and web pages. Furthermore, the content server may include a server for storing content and providing requested content.

In operation S1815, the content server may transmit requested content to the first device 100a. In operation S1820, the first device 100a may display received content. In operation S1825, the first device 100a may receive a user input to input an annotation onto displayed content. In operation S1830, the first device 100a may request the cloud server 1000 to store the annotation input by the user in correspondence to the user and the content. In operation S1835, the cloud server 1000 may store the annotation received from the first device 100a in correspondence to the user and the content. The operations S1815 through S1835 may be described with reference to the operations S1710 through S1750 in FIG. 17B.

In operation S1840, the second device 100b may receive a user input for obtaining the same content and displaying the obtained content.

For example, after the user clicks a link of a web page in the first device 100a and receives the PDF content 1810 from the web server, the second device 100b may receive a user input for clicking the same link of the same web page.

In operation S1845, the second device 100b may request content from the content server.

For example, as a user input that clicks a link of the same web page is received, the second device 100b may request content to the web server.

In operation S1850, the content server may transmit content to the device 100.

As the content request is received from the second device 100b, the content server may transmit content to the device 100.

In operation S1855, the second device 100b may request an annotation of a user stored in correspondence to the content to the cloud server 1000. In operation S1860, the cloud server 1000 may transmit the annotation of the user corresponding to the content to the second device 100b. In operation S1865, the second device 100b may display the content and the annotation of the user corresponding to the content. The operations S1855 through S1865 may be described with reference to the operations S1770 through S1790 in FIG. 17B.

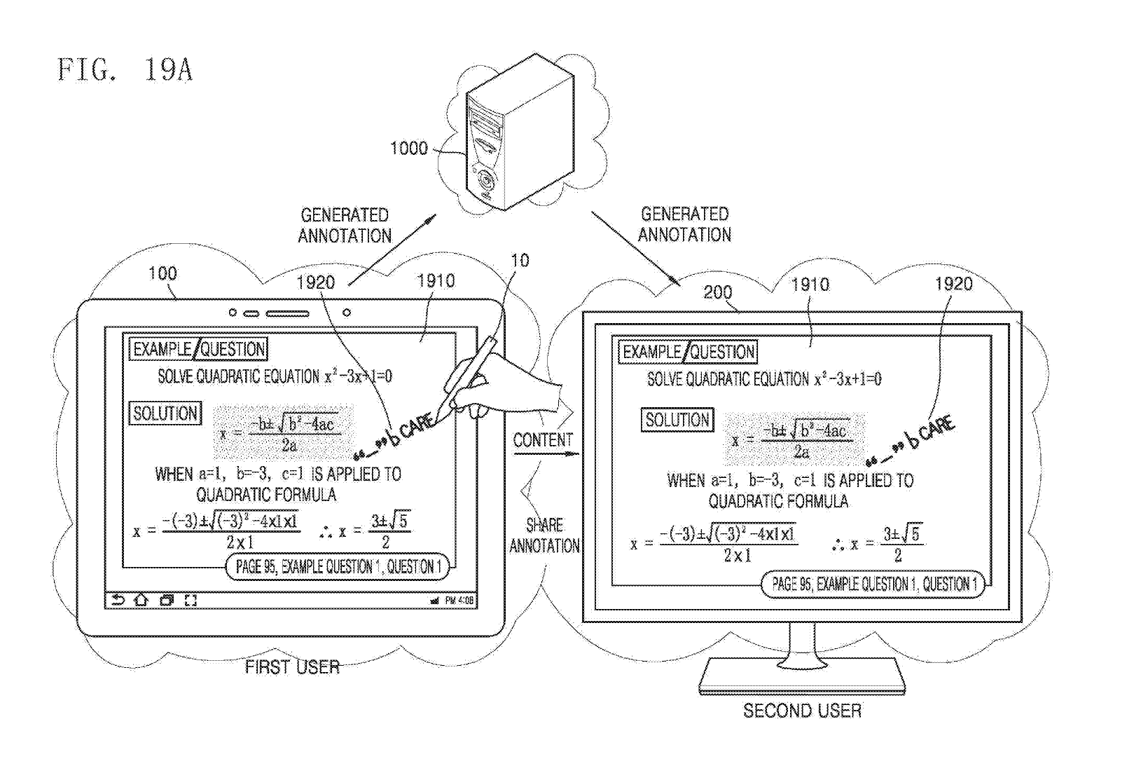

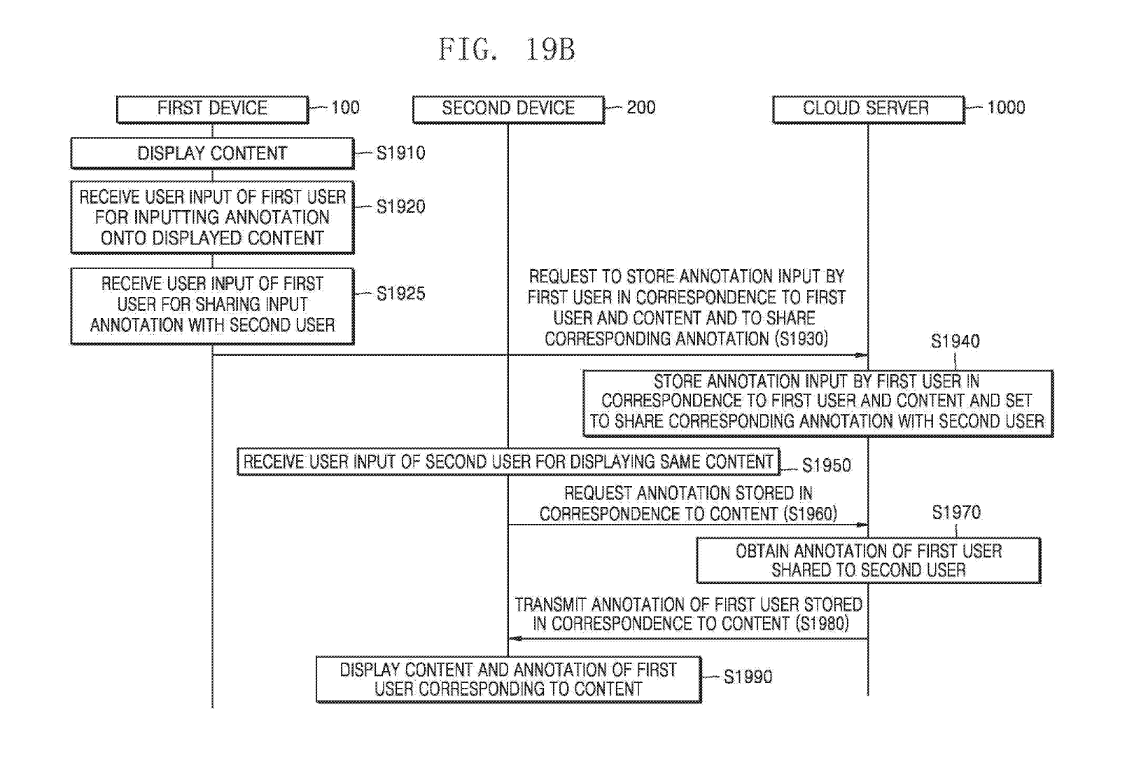

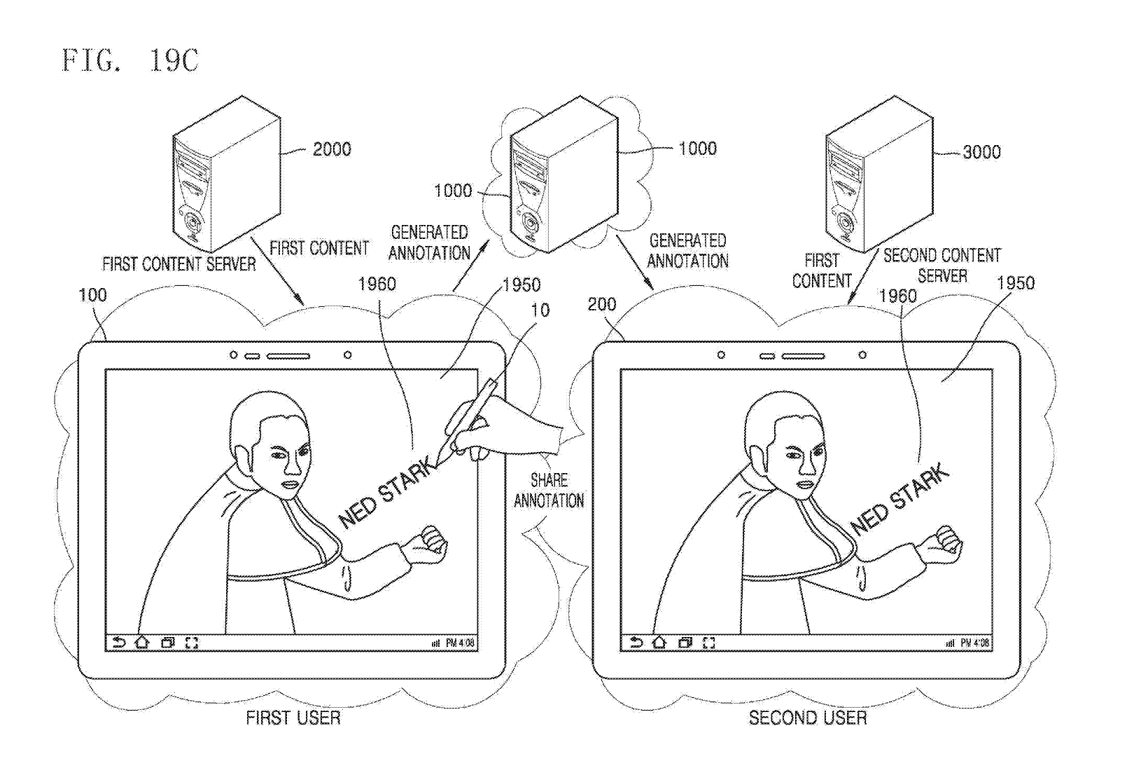

FIG. 19A is a diagram showing a method of sharing an annotation between users according to an embodiment of the present invention.

Referring to FIG. 19A, a first user and a second user may share an annotation for a same content.

A first user device 100 may display mathematics education content 1910. The filename of the mathematics education content 1910 may be “quadratic formula.PPT”. The mathematics education content 1910 may include audio information as well as image information.

The first user device 100 may receive a user input of the first user that writes a phrase “be careful for -b” 1920 by using the electronic pen 10 on the displayed mathematics education content 1910. The first user device 100 may request the cloud server 1000 to store the phrase the “be careful for -b” 1920 input by the first user in correspondence to the mathematics education content 1910. In this case, the first user device 100 may generate an image file indicating the phrase “be careful for -b” 1920 transmit the generated image file, the filename of the content, the displaying location information regarding the phrase 1920, and the ID of the first user registered in the cloud server 1000 to the cloud server 1000. Furthermore, the first user device 100 may transmit the ID of the second user registered in the cloud server 1000 to the cloud server 1000 as a user to share the annotation to.

The cloud server 1000 may store an annotation file received from the device 100 in correspondence to the ID of the first user and the filename of the content “quadratic formula.PPT”. Furthermore, the cloud server 1000 may set the second user as a sharing user of the first user. For example, the cloud server 1000 may store the ID of the second user as the ID of a sharing user of the first user.

The second user device 100 may obtain the same mathematics education content 1910. For example, the second user may receive the mathematics education content 1910 from the first user via an e-mail. Furthermore, the second user device 100 may receive a user input of the second user for displaying the mathematics education content 1910.

As the user input of the second user for displaying mathematics education content 1910 is received, the second user device 100 may request an annotation corresponding to the mathematics education content 1910 to the cloud server 1000. In this case, the second user device 100 may transmit to the cloud server 1000 the ID of the second user registered in the cloud server 1000 and identification information regarding the content, that is, “quadratic formula.PPT”.

The cloud server 1000 may obtain the annotation of the first user shared to the second user from among annotations corresponding to the file “quadratic formula.PPT”, based on the ID of the second user.

In response to the annotation request, the cloud server 1000 may transmit an image file indicating the phrase of “be careful for -b” 1920 stored in correspondence to the mathematics education content 1910 to the second user device 100.

Therefore, the second user device 100 may display the phrase “be careful for -b” 1920, which is the annotation shared by the first user to the second user for the mathematics education content 1910, on the mathematics education content 1910.

FIG. 19B is a flowchart of a method of sharing annotation between users according to an embodiment of the present invention.

In operation S1910, the first user device 100 may display the content. In operation S1920, the first user device 100 may receive a user input of a first user for inputting an annotation on the displayed information.

In operation S1925, the first user device 100 may receive a user input of the first user requesting to share the input annotation to a second user.

For example, the first user device 100 may provide a user interface for sharing the input annotations to another user.

In operation S1930, the first user device 100 may request the cloud server 1000 to store the annotation input by the first user in correspondence to the first user and the content and to share the annotation to a second user.

In this case, the first user device 100 may transmit not only an annotation file and annotation information, but also the ID of the second user registered in the cloud server cloud server 1000 to the cloud server 1000 as the ID of a sharing user.

In operation S1940, the cloud server 1000 may store the received annotation in correspondence to the first user and the content and set the annotation to be shared to the second user.

The cloud server 1000 may store an annotation received from the device 100 in correspondence to the ID of the first user and identification information regarding content. Furthermore, the cloud server 1000 may store the ID of the second user as a sharing user of the first user.

In operation S1950, the second user device 100 may receive a user input of the second user for displaying the same content.

For example, the second user device 100 may receive content identical to the content for which the first user input the annotation from the first user device 100. Furthermore, the second user device 100 may also receive content identical to the content for which the first user input annotation from a content server.

In operation S1960, the second user device 100 may request an annotation stored in correspondence to the content.

The annotation request may include the ID of the second user registered in the cloud server 1000 and identification information regarding content. For example, the second user device 100 may obtain the filename of content or the unique code of the content from the metadata of the content and transmit the obtained filename of the content or the obtained unique code of the content to the cloud server 1000.

In operation S1970, the cloud server 1000 may obtain an annotation of the first user shared to the second user from among annotations corresponding to the content.

The cloud server 1000 may obtain an annotation corresponding to the content based on identification information regarding the content received from the second user device 100. In this case, the cloud server 1000 may search for not only an annotation generated by the second user, but also annotations shared to the second user.

In operation S1980, the cloud server 1000 may transmit the annotation of the first user stored in correspondence to the content to the second user device 100. In operation S1990, the second user device 100 may display the content and the annotations of the first user corresponding to the content.

FIG. 19C is a diagram showing a method of sharing annotations between users according to another embodiment of the present invention.

Referring to FIG. 19C, an annotation may be shared between a first user and a second user for same information even when origins of contents are different.

The cloud server 1000 may be configured to share an annotation between the first user and the second user. For example, in the cloud server 1000, the ID of the second user may be stored as a sharing user in correspondence to the ID of the first user.

The first user device 100 may receive moving picture content from a first content server 2000. The filename of the moving picture content may be “Game of Thrones Season 1.avi”. Furthermore, a unique code “2345” may be recorded as metadata in the file of the moving picture content.

The first user device 100 may receive a first user input for writing a phrase “Ned Stark” 1960 on a displayed frame 1950 by using the electronic pen 10. The first user device 100 may request the cloud server 1000 to store a phrase “Ned stark” 1960 input by a first user in correspondence to the first user and the moving picture content and share the phrase to the second user.

The second user device 200 may receive the same moving picture content from a second content server 3000. The filename of the moving picture content received from the second content server 3000 may be “Game of Thrones 1.avi”. A unique code “2345” may be recorded as metadata in the file of the moving picture content received from the second content server 3000. In other words, although the moving picture content received from the first content server 2000 and the moving picture content received from the second content server 3000 are the same content, the filenames thereof may be different from each other.

The second user device 200 may obtain the unique code from the file of the moving picture content and request an annotation to the cloud server 1000 based on the obtained unique code of the file.

The cloud server 1000 may obtain an annotation of the second user corresponding to the moving picture content and an annotation shared by the first user to the second user based on the unique code of the file received from the second user device 200.

As the annotation corresponding to the moving picture content is received from the cloud server 1000, the second user device 200 may display the phrase “Ned Stark” 1960 input by the first user for the moving picture content on the same frame 1950.

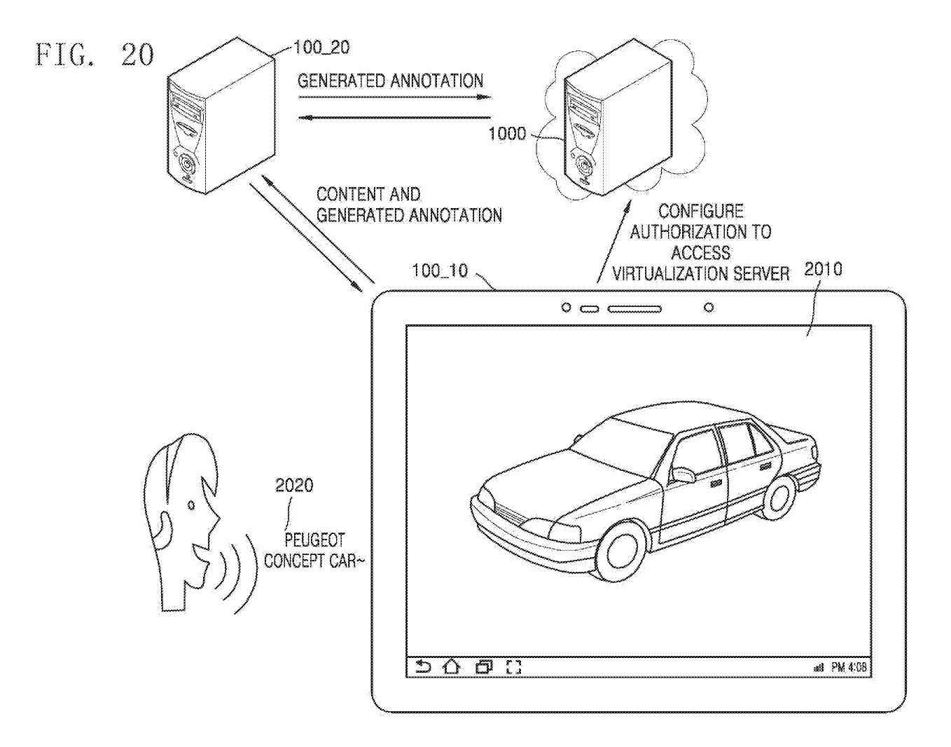

FIG. 20 is a diagram showing a method that a device 100_10 provides an annotation when the device 100_10 virtually executes an application, according to an embodiment of the present invention.

Referring to FIG. 20, an authorization to access a virtualization server 100_20 may be set to the cloud server 1000, thereby providing an annotation in case of virtually executing an application.

The device 100_10 may request the cloud server 1000 to set an authorization to access an annotation of a user to the virtualization server 100_20. The cloud server 1000 may store the ID of the virtualization server 100_20 as a user having authorization to access an annotation of the user.

The device 100_10 may make the virtualization server 100_20 to render 3D content indicating a Peugeot concept car. The filename of the 3D content indicating the Peugeot concept car may be “concept car.obj”. Furthermore, the unique number of the 3D content indicating the Peugeot concept car may be “1234”. The device 100_10 may request the virtualization server 100_20 to render 3D content to be executed on the device 100_10. The virtualization server 100_20 may generate a 3D image 2010 by rendering the 3D content requested by the device 100_10 and may transmit the generated 3D image 2010 to the device 100_10. The device 100_10 may display the 3D image 2010 received from the virtualization server 100_20, thereby providing a 3D content rendering function to a user.

The device 100_10 may receive a user input for inputting an annotation on the 3D image 2010 displayed on the display screen. As the user input for inputting the annotation is received, the device 100_10 may transmit an annotation input event to the virtualization server 100_20. For example, while the 3D image 2010 is being displayed, as a user input corresponding to a voice 2020 “Peugeot concept car” input by a user is received, the device 100_10 may transmit voice data to the virtualization server 100_20.

As the annotation input event is received from the device 100_10, the virtualization server 100_20 may generate an annotation. For example, the virtualization server 100_20 may generate a voice file expressing the phrase “Peugeot concept car” based on the voice data received from the device 100_10.

The virtualization server 100_20 may request the cloud server 1000 to store an annotation. The annotation storage request may include a voice file, information regarding an annotation, the ID of a user registered in the cloud server 1000, and identification information regarding the virtualization server 100_20 registered in the cloud server 1000. The information regarding an annotation may include the filename “concept car.obj” of a 3D content, the unique code “1234” of the 3D content, annotation playback location information, the type of the annotation, the ID of a user, and the ID of a sharing user.

As the annotation storage request is received from the virtualization server 100_20, the cloud server 1000 may determine whether the virtualization server 100_20 has authorization to access an annotation generated by a user based on the ID of the user and the identification information regarding the virtualization server 100_20 received from the virtualization server 100_20.

As it is determined that the virtualization server 100_20 has authorization to access an annotation generated by the user, the cloud server 1000 may store the annotation file and annotation information received from the virtualization server 100_20 in correspondence to the ID of the user, the filename “concept car.obj” of the content, or the unique code “1234” of the content.

The virtualization server 100_20 may receive a user input for requesting rendering from the device 100_10 after rendering of 3D content is completed. As the re-rendering request is received, the virtualization server 100_20 may request an annotation of a user corresponding to the 3D content “concept car.obj” to the cloud server 1000.

The annotation request may include the ID of a user registered in the cloud server 1000, identification information regarding the virtualization server 100_20 registered in the cloud server 1000, the filename “concept car.obj” of the content, or the unique code “1234” of the content.

As the annotation search request is received from the virtualization server 100_20, the cloud server 1000 may determine whether the virtualization server 100_20 has authorization to read an annotation of a user based on the ID of the user and the ID of the virtualization server 100_20 received from the virtualization server 100_20.

As it is determined that the virtualization server 100_20 has authorization to read an annotation of the user, the cloud server 1000 may transmit an annotation corresponding to content and annotation information to the virtualization server 100_20 based on the filename “concept car.obj” of the content or the unique code “1234” of the content

The virtualization server 100_20 may render the content “concept car.obj”. Next, based on information regarding playback location of an annotation, the virtualization server 100_20 may rebuild a 3D image as new content, such that a playback time of the 3D image 2010 corresponding to the time point at which the annotation was input is identical to the playback starting time of the annotation. Next, the cloud server 1000 may transmit the rebuilt content to the device 100_10.

The device 100_10 may play back content received from the virtualization server 100_20, thereby playing back the 3D image 2010 and an annotation 2020 corresponding to the 3D image 2010.

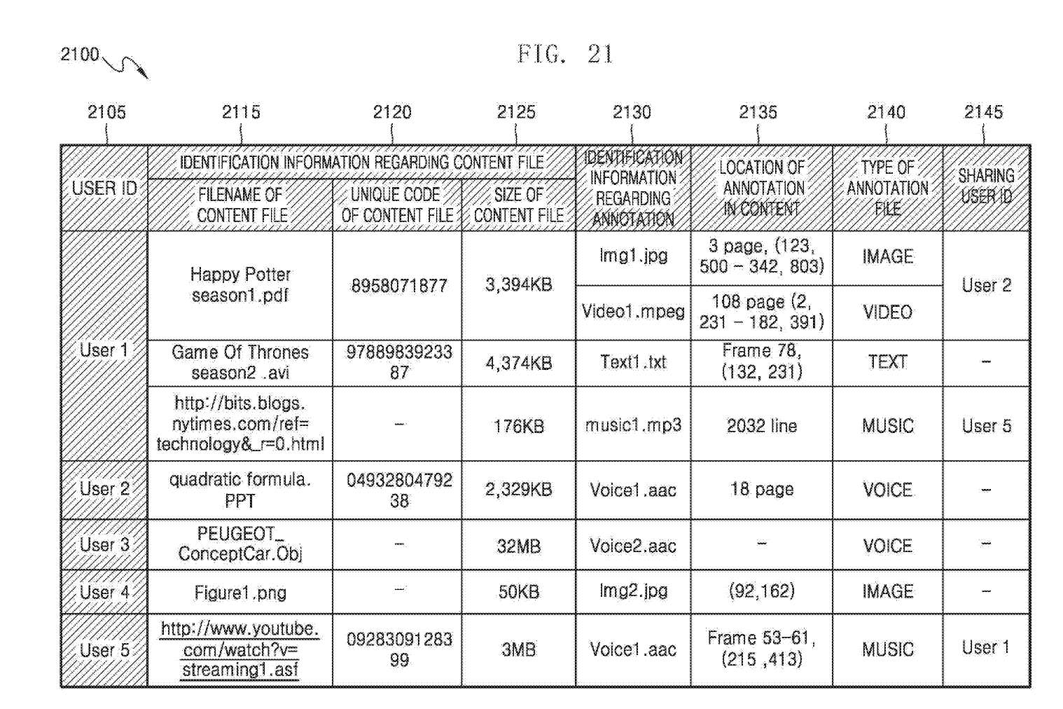

FIG. 21 is a diagram showing a database of annotations stored in the cloud server 1000 according to an embodiment of the present invention.

Referring to FIG. 21, the cloud server 1000 may store annotation files and annotation information received from the device 100 in a database 2100, in correspondence to an ID 2105 of a user.

The annotation information includes identification information 2110 regarding content, identification information 2130 regarding an annotation, information 2135 regarding location of the annotation in the content, the type 2140 of a annotation file, and the ID 2145 of a sharing user, but are not limited thereto. Furthermore, the identification information regarding the content may include, but is not limited to, a filename 2115 of the content, a unique code 2120 of the content, and a size 2125 of the content.

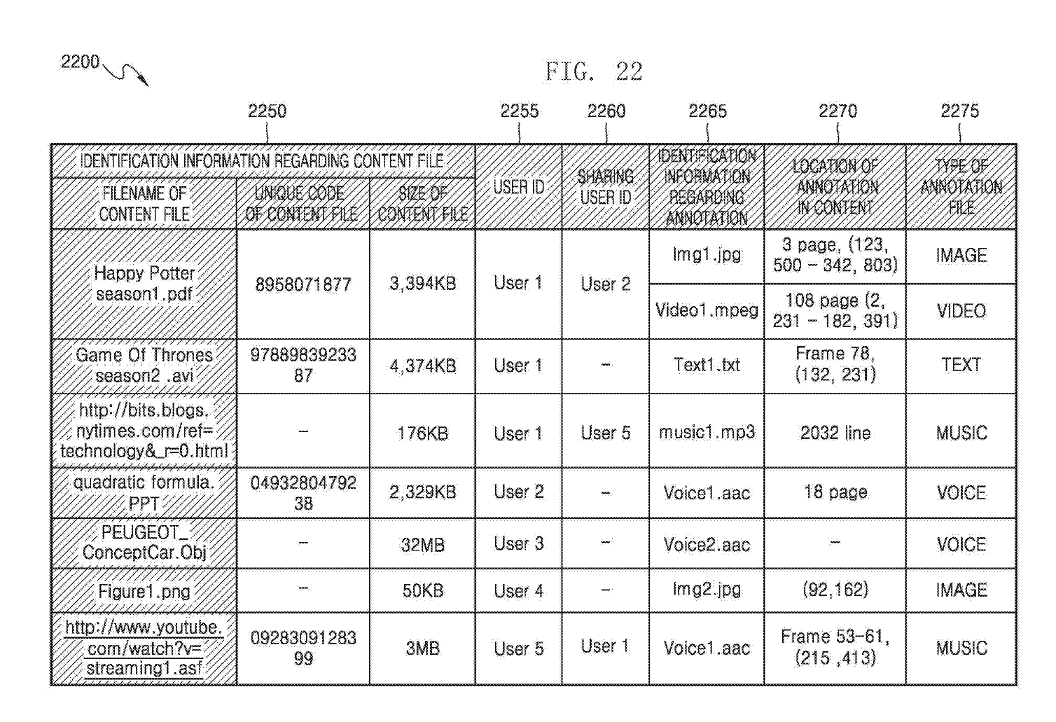

FIG. 22 is a diagram showing a database of annotations stored in the cloud server 1000 according to another embodiment of the present invention.

Referring to FIG. 22, the cloud server 1000 may store an annotation file and annotation information received from the device 100 in a database 2200 in correspondence to identification information 2250 of content.

The annotation information includes the identification information 2250 of the content, an ID 2255 of a user, an ID 2260 of a sharing user, identification information 2265 regarding the annotation, information 2270 regarding location of the annotation in the content, but are not limited thereto.

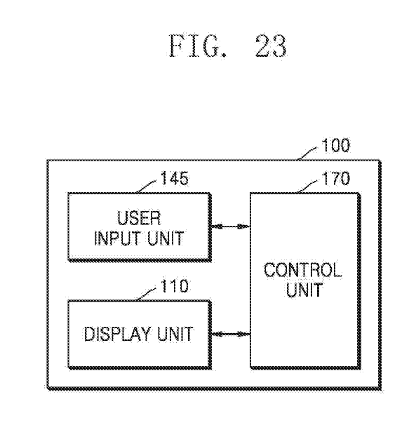

FIG. 23 is a block diagram of the device 100, according to an embodiment of the present invention.

The device 100 may include a user input unit 145, a display unit 110, and a control unit 170.

The user input unit 145 may receive a user input for inputting a search keyword. The user input unit 145 may also receive a user input for selecting one in a list of annotations associated with the search keyword. Furthermore, the user input unit 145 may receive a user input for inputting at least one of information in content as a search keyword. The user input unit 145 may receive a user input for inputting a search keyword in a search window. The user input unit 145 may receive a user input for setting at least one of a plurality of objects in the content as a search keyword.

The display unit 110 may display a list of annotations associated with the search keyword from among at least one annotation stored in correspondence to at least one content. Furthermore, the display unit 110 may display information regarding location of the selected annotation from information in the at least one content. Furthermore, the display unit 110 may display information in the content. Furthermore, the display unit 110 may display information regarding location of an annotation. Furthermore, the display unit 110 may display a search window for annotation search.

The control unit 170 may include the user input unit 145 and the display unit 110. Furthermore, the control unit 170 may obtain content in which an annotation is located based on information regarding the storage location of the annotation.

Although not shown in FIG. 22, the device 100 may further include a communication unit that requests an annotation associated with a search keyword to the cloud server 1000 and receives from the cloud server 1000 a list of annotations associated with the search keyword from among at least one annotation input in correspondence to at least one content.

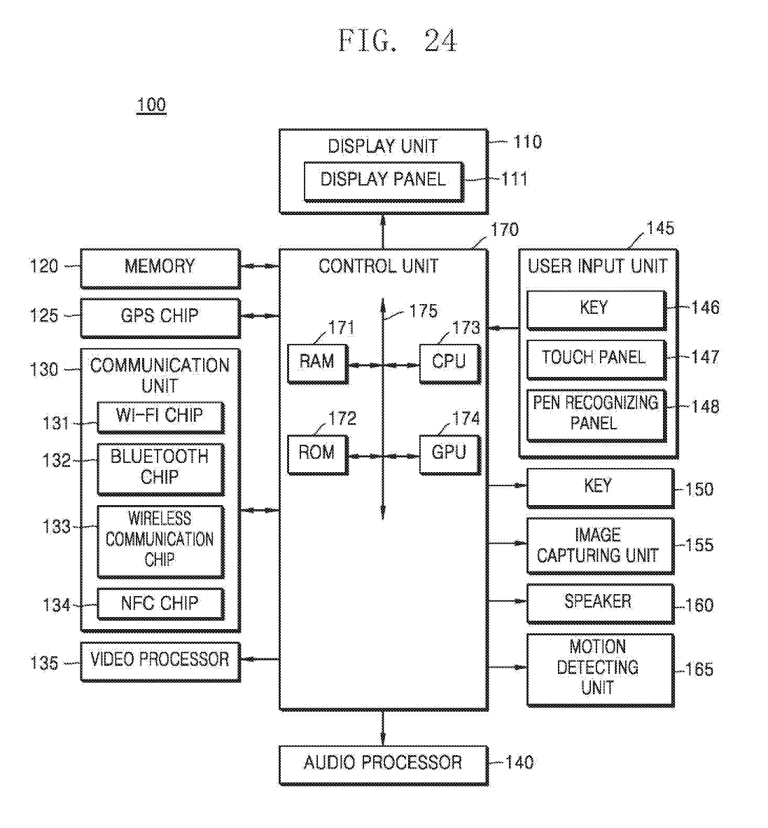

FIG. 24 is a block diagram of the device 100, according to another embodiment of the present invention.

Referring to FIG. 24, the device 100 may further include at least one of a memory 120, a GPS chip 125, a communication unit 130, a video processor 135, an audio processor 140, a microphone 150, an image capturing unit 155, a speaker 160, and a motion detecting unit 165, other than the user input unit 145, the display unit 110, and the control unit 170

The display unit 110 may include a display panel 111 and a controller (not shown) for controlling the display panel 111. The display panel 111 may be implemented with various types of displays, such as a liquid crystal display (LCD), an organic light emitting diode (OLED) display, an active matrix organic light-emitting diode (AM-OLED), and a plasma display panel (PDP). The display panel 111 may be implemented to be flexible, transparent, or wearable. The display unit 110 may be combined with a touch panel 147 of the user input unit 145 and provided as a touch screen (not shown). For example, the touch screen (not shown) may include an integrated module in which the display panel 111 and the touch panel 147 are combined with each other in a stacked structure.

The memory 120 may include at least one of an internal memory (not shown) and an external memory (not shown).

The internal memory may include at least one of a volatile memory (e.g., a dynamic RAM (DRAM), a static RAM (SRAM), a synchronous dynamic RAM (SDRAM), or the like), a non-volatile memory (e.g., an one-time programmable ROM (OTPROM), a programmable ROM (PROM), an erasable and programmable ROM (EPROM), an electrically erasable and programmable ROM (EEPROM), a mask ROM, and a flash ROM), a hard disk drive (HDD), and a solid state drive (SSD). According to an embodiment, the control unit 170 may load and process commands or data received from at least one of a non-volatile memory or other components into a volatile memory. Furthermore, the control unit 170 may store data generated by or received from other components in a non-volatile memory.

The external memory may include at least one of a compact flash (CF), a secure digital (SD), a micro secure digital (micro-SD), a mini secure digital (Mini-SD), an extreme digital (xD), and a memory stick, for example.

The memory 120 may store various programs and data used for operations of the device 100. For example, the memory 120 may temporarily or permanently store at least a portion of content to be displayed on a lock screen.

The control unit 170 may control the display unit 110, such that a portion of content stored in the memory 120 is displayed on the display unit 110. In other words, the control unit 170 may display a portion of content stored in the memory 120 on the display unit 110. Alternatively, the control unit 170 may perform a control operation corresponding to a user's gesture when the user's gesture is performed on an area of the display unit 110.

The control unit 170 may include at least one of a RANI 171, a ROM 172, a CPU 173, a graphic processing unit (GPU) 174, and a bus 175. The RAM 171, the ROM 172, the CPU 173, and the GPU 174 may be connected to one another via the bus 175.

The CPU 173 may access the memory 120 and perform booting by using an 0/S stored in the memory 120. Furthermore, various operations may be performed by using various programs, contents, and data stored in the memory 120.

The ROM 172 may store a command set for booting a system. For example, when a turn ON command is input and power is supplied, the CPU 173 may copy the 0/S stored in the memory 120 to the RAM 171 according to a command stored in the ROM 172 and may boot the system by executing the O/S.

Furthermore, the memory 120 may store at least one program for performing an embodiment of the present disclosure. The CPU 173 may perform an embodiment of the present disclosure by copying at least one program stored in the memory 120 to the RAM 171 and executing the copied program in the RAM 171. The GPU 174 may display a UI screen in an area of the display unit 110 when the booting of the device 100 is completed. Specifically, the GPU 174 may generate a screen image that displays an electronic document including various objects, e.g., contents, icons, menus, etc. The GPU 174 may calculate attribute values, such as coordinate values, shapes, sizes, and colors, for displaying respective objects according to a layout of a screen image. The GPU 174 may generate screen images of various layouts including objects based on calculated attribute values. Screen images generated by the GPU 174 may be provided to the display unit 110 and displayed in respective areas of the display unit 110.

The GPS chip 125 may receive a GPS signal from a global positioning system (GPS) satellite and calculate a current position of the device 100. The control unit 170 may calculate location of a user by using the GPS chip 125 for using a navigation program or when a current location of the user is necessary for other reasons.

The communication unit 130 may perform a communication with various types of external devices 100 according to various types of communication protocols. The communication unit 130 may include at least one of a Wi-Fi chip 131, a Bluetooth chip 132, a wireless communication chip 133, and an NFC chip 134. The control unit 170 may communicate with the various external devices 100 by using the communication unit 130.

The Wi-Fi chip 131 and the Bluetooth chip 132 may perform communications by using the Wi-Fi protocol and the Bluetooth protocol, respectively. When the Wi-Fi chip 131 or the Bluetooth chip 132 is used, various connection information, such as an SSID and a session key, may be transmitted and received first, and the communication information may be used to establish a communication, and then various information may be transmitted and received. The wireless communication chip 133 refers to a chip that performs a communication according to various communication standards, such as IEEE, ZigBee, 3rd generation (3G), 3rd generation partnership project (3GPP), and long term evolution (LET). The NFC chip 134 refers to a chip operating in the near field communication (NFC) mode using the 13.56 MHz band from among various RF-ID frequency bands, such as 135 kHz, 13.56 MHz, 433 MHz, 860 to 960 MHz, and 2.45 GHz.

The video processor 135 may process video data included in content received through the communication unit 130 or content stored in the memory 120. The video processor 135 may perform various image processings, such as decoding, scaling, noise filtering, frame rate conversion, and resolution conversion, on video data.

The audio processor 140 may process audio data included in content received through the communication unit 130 or content stored in the memory 120. At the audio processor 140, various processings, such as decoding, amplification, and noise filtering, may be performed on audio data.

When a playback program for multimedia content is executed, the control unit 170 drives the video processor 135 and the audio processor 140 to play back corresponding content. The speaker 160 may output audio data generated by the audio processor 140.

The user input unit 145 may receive various commands from a user. The user input unit 145 may include at least one of a key 146, a touch panel 147, and a pen recognizing panel 148.

The key 146 may include various types of keys, such as mechanical buttons and wheels, formed in various areas, such as the front surface, side surfaces, or the rear surfaces, of the exterior of the device 100.

The touch panel 147 may sense a touch input of a user and may output a touch event value corresponding to a sensed touch signal. When the touch panel 147 is combined with the display panel 111 to form a touch screen (not shown), the touch screen may be implemented with various types of touch sensors, such as an electrostatic sensor, a pressure sensitive sensor, and a piezoelectric sensor. An electrostatic sensor is a type for calculating touch coordinates by sensing minute electricity generated by a user's body when a portion of the user's body touches a the touch screen surface by using a dielectric coated on the touch screen surface. A pressure sensitive sensor includes two electrode plates embedded in a touch screen and, when a user touches the touch screen, the upper and lower plates of a touched point contact each other. As a result, a current flow is sensed, and touch coordinates are calculated. A touch event that occurs on a touch screen may be mainly generated by a finger of a person, but may also be generated by an object of a conductive material capable of changing a electrostatic capacitance.

The pen recognizing panel 148 may detect a proximity input or a touch input of a pen due to manipulation of a user's touch pen (e.g., a stylus pen or a digitizer pen) and output a sensed pen proximity event or a sensed pen touch event. For example, the pen recognizing panel 148 may be implemented in an EMR manner and may sense a touch input or a proximity input according to a change in intensity of electromagnetic field due to proximity or touch of a pen. In detail, the pen recognizing panel 148 includes an electromagnetic induction coil sensor (not shown) having a grid-like structure and an electronic signal processing unit (not shown) for sequentially providing an AC signal having a predetermined frequency to respective loop coils of the electromagnetic induction coil sensor. When there is a pen incorporating a resonant circuit in the vicinity of a the loop coil of the pen recognizing panel 148, a magnetic field transmitted from the corresponding loop coil generates a current based on mutual electromagnetic induction at a resonant circuit in the pen. Based on this current, an induction magnetic field is generated from coils constituting the resonant circuit in the pen, and the pen recognizing panel 148 detects the induction magnetic field at the loop coil in the signal receiving state. As a result, a proximity location or a touched location of a pen may be sensed. The pen recognizing panel 148 may be provided below the display panel 111 with a sufficient area covering the display area of the display panel 111, for example.

The microphone 150 may receive a user voice or other sounds and convert it into audio data. The control unit 170 may use a user voice input through the microphone 150 in a phone call operation or convert the user voice into audio data and store the audio data in the memory 120.

The image capturing unit 155 may capture a still image or a moving picture under the control of a user. The image capturing unit 155 may be implemented with a plurality of cameras, such as a front camera and a rear camera.

When the image capturing unit 155 and the microphone 150 are provided, the control unit 170 may perform a control operation based on a user's voice input through the microphone 150 or the user's motion recognized by the image capturing unit 155. For example, the device 100 may operate in a motion control mode or a voice control mode. When the device 100 operates in the motion control mode, the control unit 170 may activates the image capturing unit 155 to photograph a user, track a change in a motion of the user, and perform a corresponding control operation. When the device 100 operates in the voice control mode, the control unit 170 may operate in a voice recognition mode for analyzing a user's voice input through the microphone 150 and performs a control operation according to the analyzed user voice.

The motion detecting unit 165 may detect a motion of the main body of the device 100. The device 100 may be rotated or tilted in various directions. At this time, the motion detecting unit 165 may detect motion characteristics, such as a direction and an angle of rotation and a tilted angle, by using at least one of various sensors, such as a geomagnetic sensor, a gyro sensor, and an acceleration sensor.

Furthermore, although not shown in FIG. 24, the device 100 according to an embodiment may further include a USB port through which a USB connector may be connected in the device 100, various external input ports for connecting various external terminals, such as a headset, a mouse, and a LAN, a digital multimedia broadcasting (DMB) chip for receiving and processing a DMB signal, and various sensors.

The names of the components of the device 100 described above may vary. Furthermore, the device 100 according to the present disclosure may be configured to include at least one of the above-described components, wherein some of the components may be omitted or additional components may be added.

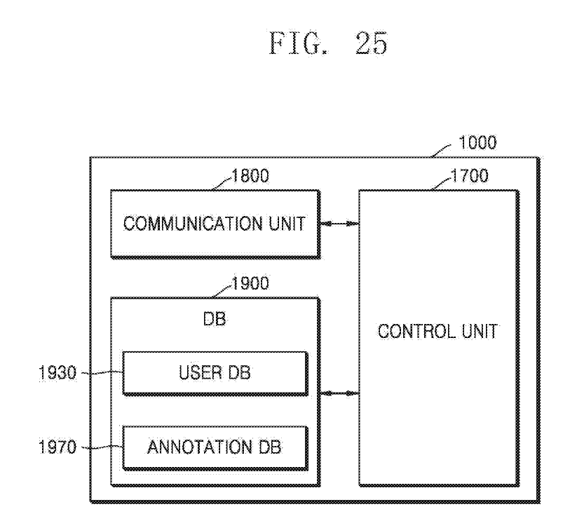

FIG. 25 shows a block diagram of the cloud server 1000, according to an embodiment of the present invention.

Referring to FIG. 25, the cloud server 1000 may include a control unit 1700, a communication unit 1800, and a database 1900.

The control unit 1700 may control the overall hardware components of the cloud server 1000 including the communication unit 1800 and the database 1900.

The database 1900 may include a user database 1930 and an annotation database 1970.

The user database 1930 may store accounts of users registered in the cloud server 1000.

Furthermore, the annotation database 1970 may store annotations in correspondence to the identification information regarding the users registered in the cloud server 1000. An annotation may include an annotation file and information regarding the annotation file. The annotation information may include identification information regarding content, the ID of a sharing user, identification information regarding the annotation, information regarding location of the annotation in content, and the type of the annotation file.

The communication unit 1800 may perform communication with various types of devices 100 according to various types of communication protocols. For example, the communication unit 1800 may transmit and receive an annotation of a user to and from the device 100.

The control unit 1700 may receive an annotation storage request from the device 100 via the communication unit 1800.

For example, the control unit 1700 may be requested by the device 100 to store an annotation in correspondence to a tag. As the annotation storage request is received from the device 100, the cloud server 1000 may store a received annotation in correspondence to the tag.

Furthermore, the control unit 1700 may also receive an annotation search request from the device 100 via the communication unit 1800. For example, the control unit 1700 may request an annotation associated with a search keyword to the device 100. The annotation search request may include a search keyword, identification information regarding output content, and the ID of a user registered in the cloud server 1000.

As the annotation search request is received from the device 100, the control unit 1700 may determine at least one tag associated with the search keyword. The control unit 1700 may obtain at least one annotation corresponding to the determined tag, thereby obtaining an annotation associated with the search keyword.

As the annotation associated with the search keyword is obtained, the control unit 1700 may transmit a list of annotations associated with the search keyword to the device 100 through the communication unit 1800. The control unit 1700 may transmits the list of annotations together with tags, identification information regarding annotation-set content, storage location information regarding content, information regarding location of annotations in content, and the IDs of owner who own the annotations to the device 100.

The control unit 1700 may also be requested by the device 100 to store an annotation in correspondence to a user and content via the communication unit 1800. As the request to store an annotation in correspondence to a user and content is received from the device 100, the control unit 1700 may store an annotation corresponding to the user and the content.

Furthermore, the control unit 1700 may receive a request for an annotation of a user corresponding to content from the device 100 through the communication unit 1800. As an annotation of a user corresponding to content is requested, the control unit 1700 may obtain an annotation of the user corresponding to the content based on identification information regarding the user and identification information regarding the content, and transmit the obtained annotation to the device 100 via the communication unit 1800.

One or more exemplary embodiments may be implemented by a computer-readable recording medium, such as a program module executed by a computer. The computer-readable recording medium may be an arbitrary available medium accessible by a computer, and examples thereof include all volatile media (e.g., RANI) and non-volatile media (e.g., ROM) and separable and non-separable media. Further, examples of the computer-readable recording medium may include a computer storage medium and a communication medium. Examples of the computer storage medium include all volatile and non-volatile media and separable and non-separable media, which have been implemented by an arbitrary method or technology, for storing information such as computer-readable commands, data structures, program modules, and other data. The communication medium typically include a computer-readable command, a data structure, a program module, other data of a modulated data signal, or another transmission mechanism, and an example thereof includes an arbitrary information transmission medium.

While the present invention has been particularly shown and described with reference to exemplary embodiments thereof, it will be understood by those of ordinary skill in the art that various changes in form and details may be made therein without departing from the spirit and scope of the present invention as defined by the following claims. Hence, it will be understood that the exemplary embodiments described above are not limiting the scope of the present invention. For example, each component described in a single type may be executed in a distributed manner, and components described distributed may also be executed in an integrated form.

The scope of the present invention is indicated by the claims which will be described in the following rather than the detailed description of the exemplary embodiments, and it should be understood that the claims and all modifications or modified forms drawn from the concept of the claims are included in the scope of the present invention.

1. A device comprising:
a user input unit configured to receive a user input for inputting a search keyword;
a display unit configured to display a list of annotations associated with the search keyword from among at least one annotation set with respect to at least one content; and
a control unit configured to control the unit input unit and the display unit,
wherein the user input unit is further configured to receive a user input for selecting at least one in the list of annotations, and
the display unit is further configured to display content for which the selected annotation is set from among the at least one content.

2. The device of claim 1, wherein the display unit is further configured to display information regarding first content different from the at least one content, and
the user input unit is further configured to input at least one from the information in the first content as a search keyword.

3. The device of claim 1, wherein the at least one annotation input to the at least one content is at least one of an annotation stored in a cloud server in correspondence to an identification (ID) of the user and an annotation that is shared with the user in correspondence to the ID of the user and stored in the cloud server.

4. The device of claim 3, wherein the device is further configured to request the cloud server for an annotation associated with the search keyword,
the device further comprises a communication unit configured to receive the list of annotations associated with the search keyword from among at least one at least one input in correspondence to the at least one content from the cloud server, and
the display unit is further configured to display the received list of annotations.

5. The device of claim 1, wherein the list of annotations associated with the search keyword comprises storage location information regarding the annotation,
the control unit is further configured to obtain content in which the selected annotation is located, based on storage location information regarding the annotation; and
the display unit is further configured to display information regarding a location of the annotation from information in the content.

6. The device of claim 1, wherein the display unit is further configured to display a search window, and
the user input unit is further configured to input the search keyword in the search window.

7. The device of claim 2, wherein the first content comprises a plurality of objects, and
the user input unit is further configured to receive a user input for setting at least one of the plurality of objects as the search keyword.

8. A method of providing annotation, the method comprising:
receiving a user input for inputting a search keyword;
displaying a list of annotations related to the search keyword from among at least one annotation stored in correspondence to at least one content;
receiving a user input for selecting one in the list of annotations; and
displaying information including the selected annotation from information in the at least one content.

9. The method of claim 8, wherein the receiving of the user input for inputting the search keyword comprises:
displaying information in first content different from the at least one content; and
receiving at least one of information in the first content as the search keyword.

10. The method of claim 8, wherein at least one annotation input to the at least one content is at least one of an annotation stored in a cloud server in correspondence to an ID of the user and an annotation that is shared with the user in correspondence to the ID of the user and stored in the cloud server.

11. The method of claim 10, wherein the displaying of the list of the annotations related to the search keyword from among the at least one annotation stored in correspondence to the at least one content comprises:
requesting an annotation associated with the search keyword to the cloud server;
receiving the list of annotations associated with the search keyword from among at least one at least one input in correspondence to the at least one content from the cloud server; and
displaying the received list of annotations.

12. The method of claim 8, wherein the list of annotations associated with the search keyword comprises information regarding locations at which the annotations are stored, and
the displaying of the information in which the selected annotation is located from the information in the at least one content comprises:
obtaining content in which the selected annotation is located based on the information regarding locations where the annotations are stored; and
displaying information including the selected annotation from information in the content.

13. The method of claim 8, wherein the receiving of the user input for inputting the search keyword comprises:
displaying a search window for searching for an annotation; and
receiving a user input for inputting the search keyword in the search window.

14. The method of claim 9, wherein the first content comprises a plurality of objects, and,
in the receiving of the user input for inputting the search keyword, at least one of the plurality of objects is set as the search keyword.
